(19) United States
(12) Patent Application Publication
(10) Pub. No.: US 2025/0051614 A1
(43) Pub. Date: Feb. 13, 2025

(54) ADHESIVE SYSTEM INCLUDING A TAPE WITH A FOAM SUPPORT LAYER

(71) Applicant: 3M INNOVATIVE PROPERTIES COMPANY, St. Paul, MN (US)

(72) Inventors: Alexander J. Kugel, Woodbury, MN (US); Nicholas W. Lang, Minnetonka, MN (US); Tzu-Yu Lai, Minnetonka, MN (US); Dean A. Miner, Prescott, WI (US); Matthew T. Holbrook, Little Canada, MN (US); Scott M. Spear, St. Paul, MN (US); Kristen L. Bellmer, Cottage Grove, MN (US); Frank Kuester, Düsseldorf (DE); Hans Peter Dette, Neuss (DE); Kerstin Unverhau, Neuss (DE); Silke Mechernich, Düsseldorf (DE); Duane D. Fansler, Dresser, WI (US); Anthony F. Schultz, Forest Lake, MN (US); Jonathan E. Janoski, Woodbury, MN (US)

(21) Appl. No.: 18/720,307

(22) PCT Filed: Dec. 15, 2022
(86) PCT No.: PCT/IB2022/062329

§ 371 Date: Jun. 14, 2024

Related U.S. Application Data
(60) Provisional application No. 63/290,214, filed on Dec. 16, 2021.
(60) Provisional application No. 63/426,180, filed on Nov. 17, 2022.

(51) Int. Cl. C09J 7/35; C09J 7/26; C09J 7/29

(52) U.S. Cl. CPC C09J 7/35; C09J 7/26; C09J 7/29; C09J 2301/124; C09J 2301/304; C09J 2301/41

(57) ABSTRACT

An adhesive system comprising a tape and an activator, wherein the activator includes an oxidizing agent and is a liquid at normal temperature and pressure; and wherein the tape includes a curable adhesive free-standing film adjacent to a curable foam support layer, wherein the curable adhesive free-standing film comprises: a) a film-forming polymer or oligomer; b) a species comprising unsaturated free-radically polymerizable groups, which may be a) or a species other than a); and c) a transition metal cation.

### BACKGROUND

Curable adhesive films, and tapes that include such films, are known. Such films and tapes are typically used with a species that activates the cure of the adhesive upon contact resulting in a structural adhesive bond. The adhesive films may be pressure sensitive adhesives prior to cure, and the tapes may include a foam support layer; however, additional adhesive systems are needed with foam support layers that have improved strength and gap-spanning performance.

### SUMMARY

In one aspect, provided is an adhesive system comprising a tape and an activator for adhesion of a curable adhesive free-standing film to a substrate, wherein the activator is a liquid at normal temperature and pressure and includes an oxidizing agent; and wherein the tape includes a curable adhesive free-standing film adjacent to a curable foam support layer, wherein the curable adhesive free-standing film comprises a) a film-forming polymer or oligomer; b) a species comprising unsaturated free-radically polymerizable groups, which may be a) or a species other than a); and c) a transition metal cation.

In another aspect, provided is an adhesive system as described above wherein the curable adhesive free-standing film is a first curable adhesive free-standing film; the tape additionally comprises a second curable adhesive free-standing film, wherein the second curable adhesive free-standing film comprises components comprising a′) a film-forming polymer or oligomer; b′) a species comprising unsaturated free-radically polymerizable groups, which may be a′) or a species other than a′); and c′) a transition metal cation; and the second curable adhesive free-standing film is adjacent to a surface of the curable foam support layer opposite the first curable adhesive free-standing film.

Embodiments are also provided that include a barrier film support layer in addition to the curable foam support layer.

In another aspect, the present disclosure provides a method of making a bonded article. The method includes applying the tape as described above to a first substrate, applying an activator as described to a second substrate, and contacting the tape on the first substrate and the activator on the second substrate to bond the first and second substrates. Other methods of using the adhesive system of the present disclosure are also described.

The term “curable” means crosslinkable upon contact with the activator. Both the foam support layer and adhesive free-standing film are curable in that they are crosslinkable; however, they may be crosslinkable via the same or a different mechanism.

The term adjacent, as used throughout the description, refers to two superimposed layers within the tape or constructions including the tape, activator, and one or more substrates, which are arranged directly next to each other, i.e., which are abutting each other and are typically in direct contact with each other.

In two adjacent layers, one layer may be “borne on” another or one may be “directly bound to” another. In the former, the layers are typically made in one step, such as occurs in a coating or coextrusion process. In the latter, the layers are typically made in two or more steps, such as occurs in a lamination process.

The term “film-forming” means capable of forming a continuous and coherent film, which in some embodiments may result from one or more of solidification, curing, drying, or solvent removal of a melt, solution, suspension, or the like.

The term “free-standing film” means a film that is solid at normal temperature and pressure and has mechanical integrity independent of contact with any supporting material (which excludes, inter alia, liquids, surface coatings dried or cured in situ such as paints or primers, and surface coatings without independent mechanical integrity).

The term “hot melt processable” in the context of one of the polymer-containing layers or films described herein means the polymer-containing composition includes little or no conventional solvent (which is various embodiments may be less than 5 weight percent, less than 3 weight percent, less than 1 weight percent, less than 0.5 weight percent, less than 0.1 weight percent, or less than 0.01 weight percent of conventional solvent), which may be hot melt processed under conventional conditions, where hot melt process includes hot melt blending and extruding.

The term “(meth)acrylate” includes, separately and collectively, methacrylate and acrylate.

The term “monomer unit” of a polymer or oligomer is a segment of a polymer or oligomer derived from a single monomer.

The term “normal temperature and pressure” or “NTP” means a temperature of 20° C. (293.15 K, 68° F.) and an absolute pressure of 1 atm (14.696 psi, 101.325 kPa).

The term “pendant” in the context of functional groups of a polymer or oligomer are functional groups that do not form a part of the backbone of the polymer or oligomer and are not terminal groups of the polymer.

The term “structural adhesive” means an adhesive that binds by irreversible cure, typically with a strength when bound to its intended substrates, measured as stress at break (peak stress) using the Dynamic Shear Adhesion Test described in the Examples Section, of at least 4.52 MPa (655 psi), more typically at least 5.36 MPa (777 psi), and in some embodiments at least 6.29 MPa (912 psi).

The term “glass transition temperature” or “Tg” refers to the temperature at which a material changes from a glassy state to a rubbery state. In this context, the term “glassy” means that the material is hard and brittle (and therefore relatively easy to break) while the term “rubbery” means that the material is elastic and flexible. For polymeric materials, the Tg is the critical temperature that separates their glassy and rubbery behaviors. If a polymeric material is at a temperature below its Tg, large-scale molecular motion is severely restricted because the material is essentially frozen. On the other hand, if the polymeric material is at a temperature above its Tg, molecular motion on the scale of its repeat unit takes place, allowing it to be soft or rubbery. Any reference herein to the Tg of a monomer refers to the Tg of a homopolymer formed from that monomer. The glass transition temperature of a polymeric material is often determined using methods such as Dynamic Mechanical Analysis (“DMA”) or Differential Scanning Calorimetry (e.g., Modulated Differential Scanning Calorimetry). Alternatively, the glass transition of a polymeric material can be calculated using the Fox Equation if the amount and Tg of each monomer used to form the polymeric material are known.

The term “alkyl” refers to a monovalent group which is a saturated hydrocarbon. The alkyl can be linear, branched, cyclic, or combinations thereof, and typically has 1 to 32 carbon atoms. Unless otherwise indicated, the alkyl group contains 1 to 25, 1 to 20, 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, 2-ethylhexyl, 2-octyl and 2-propylheptyl.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “aralkyl” refers to a monovalent group that is an alkyl substituted with an aryl group (e.g., as in a benzyl group). The term “alkaryl” refers to a monovalent group that is an aryl substituted with an alkyl group (e.g., as in a tolyl group). Unless otherwise indicated, for both groups, the alkyl portion often has 1 to 10 carbon atoms, 1 to 6 carbon atoms, or 1 to 4 carbon atoms and an aryl portion often has 6 to 20 carbon atoms, 6 to 18 carbon atoms, 6 to 16 carbon atoms, 6 to 12 carbon atoms, or 6 to 10 carbon atoms.

The term “alkylene” refers to a divalent group that is a radical of an alkane and includes groups that are linear, branched, cyclic, bicyclic, or a combination thereof. Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms. Examples of “alkylene” groups include methylene, ethylene, propylene, 1,4-butylene, 1,4-cyclohexylene, and 1,4-cyclohexyldimethylene.

The term “arylene” refers to a divalent group that is aromatic and, optionally, carbocyclic. The arylene has at least one aromatic ring. Optionally, the aromatic ring can have one or more additional carbocyclic rings that are fused to the aromatic ring. Any additional rings can be unsaturated, partially saturated, or saturated. In some embodiments, the arylene group has up to 5 rings, up to 4 rings, up to 3 rings, up to 2 rings, or one aromatic ring. For example, the arylene group can be phenylene. Unless otherwise specified, arylene groups often have 6 to 20 carbon atoms, 6 to 18 carbon atoms, 6 to 16 carbon atoms, 6 to 12 carbon atoms, or 6 to 10 carbon atoms.

The term “aralkylene” refers to a divalent group that is an alkylene group substituted with an aryl group or an alkylene group attached to an arylene group. The term “alkarylene” refers to a divalent group that is an arylene group substituted with an alkyl group or an arylene group attached to an alkylene group. Unless otherwise indicated, for both groups, the alkyl or alkylene portion typically has from 1 to 20 carbon atoms, 1 to 10 carbon atoms, 1 to 6 carbon atoms, or 1 to 4 carbon atoms. Unless otherwise indicated, for both groups, the aryl or arylene portion typically has from 6 to 20 carbon atoms, 6 to 18 carbon atoms, 6 to 16 carbon atoms, 6 to 12 carbon atoms, or 6 to 10 carbon atoms.

The term “hydrocarbyl” is inclusive of aryl and alkyl.

As used herein, the term “or” is generally employed in its usual sense including “and/or” unless the content clearly dictates otherwise.

As used herein, the term “and/or” is used to indicate one or both stated cases may occur, for example A and/or B includes, (A and B) and (A or B).

As used herein, the term “room temperature” refers to a temperature in the range of 20° C. to 25° C.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other claims are not useful and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.) and any sub-ranges (e.g., 1 to 5 includes 1 to 4, 1 to 3, 2 to 4, etc.).

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIG. 1 is a cross section of one embodiment of a tape according to the present disclosure.

FIG. 2 is a cross section of one embodiment of a double-sided tape with two curable adhesive free-standing film layers, according to the present disclosure.

FIG. 3 is a cross section of one embodiment of a construction using a double-sided tape of the type shown in FIG. 2, according to the present disclosure, wherein the curable and cured layers are referred to by the same numerical designations. Construction 300 includes substrate 320, activator 370, tape 310 (including curable or cured adhesive layer 340, curable or cured foam support layer 350, curable or cured adhesive layer 360), activator 380, and substrate 330.

FIG. 4 is a cross section of one embodiment of a double-sided tape with only one curable adhesive free-standing film layer, according to the present disclosure.

FIG. 5 is a cross section of one embodiment of a double-sided multi-layer tape with a barrier film support layer, according to the present disclosure.

FIG. 6 is migration data of crosslinker from the FTIR Migration Test.

FIG. 7 is a cross section of another embodiment of a construction using a double-sided tape of the type shown in FIG. 2, according to the present disclosure.

### DETAILED DESCRIPTION OF ILLUSTRATIVE EMBODIMENTS

The present disclosure provides an adhesive system comprising a tape and an activator. The tape includes a curable adhesive free-standing film adjacent to a curable foam support layer. The activator is a liquid at normal temperature and pressure and includes an oxidizing agent. The activator is used to initiate cure of the curable adhesive free-standing film while in contact with a substrate, thereby forming a structural adhesive bond between the tape and the substrate.

The present adhesive system does not require mixing of liquid components for use; rather, the activator is applied to a substrate and the activator-coated substrate contacted with the curable adhesive free-standing film of the tape. Upon contact with an activator-coated substrate, the curable adhesive films of the tapes of the present disclosure begin to cure, resulting in structural adhesive bonds. In some embodiments of the present adhesive system, cure can be achieved at normal temperature and pressure, without heat or autoclave. Likewise, in some embodiments of the present adhesive system, cure can be achieved without UV or other radiation treatment, and cure propagates well to areas inaccessible to radiation cure. In some embodiments of the present adhesive system, components of the present adhesive system need not be refrigerated or kept in dark storage.

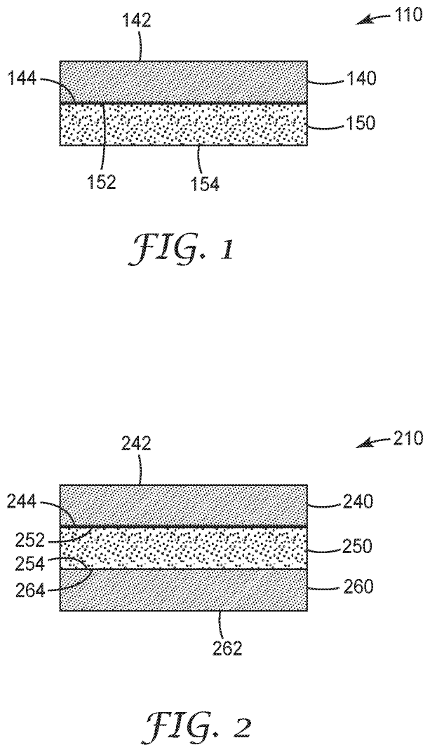

As shown in FIG. 1 (not to scale), an exemplary tape 110 includes a curable adhesive free-standing film 140 (having two major surfaces 142 and 144) adjacent to a curable foam support layer 150 (having two major surfaces 152 and 154). The curable adhesive free-standing film comprises: a) a film-forming polymer or oligomer; b) a species comprising unsaturated free-radically polymerizable groups, which may be a) or a species other than a); and c) a transition metal cation. In certain embodiments, b) is a) in the curable adhesive free-standing film. In certain embodiments, b) is a species other than a), wherein a) does not comprise unsaturated free-radically polymerizable groups.

In the tapes described herein, a curable adhesive free-standing film 140 may be borne on a curable foam support layer (e.g., a major surface 152 of the curable foam support layer 150 of FIG. 1). That is, the layers are typically made in one step, such as occurs in a coating or coextrusion process. Alternatively, a curable adhesive free-standing film 140 is directly bound to a curable foam support layer (e.g., a major surface 152 of the curable foam support layer 150 of FIG. 1). That is, the layers are typically made in two or more steps, such as occurs in a lamination process. Such procedures are well-known in the preparation of tapes. However made, a major surface 144 of the curable adhesive free-standing film 140 is adjacent to a major surface 152 of the curable foam support layer 150.

In certain embodiments, the tape is a double-sided tape with one curable adhesive free-standing film adjacent each major surface of a curable foam support layer (i.e., a second curable adhesive free-standing film is adjacent the surface opposite the first curable adhesive free-standing film). Thus, in this embodiment, a first curable adhesive free-standing film is adjacent to a first major surface of a curable foam support layer, and a second curable adhesive free-standing film is adjacent to a second major surface of the curable foam support layer.

As shown in FIG. 2 (not to scale), an exemplary double-sided tape 210 includes a first curable adhesive free-standing film 240 (having two major surfaces 242 and 244), and a second curable adhesive free-standing film 260 (having two major surfaces 262 and 264), each of which are adjacent to opposite surfaces of a curable foam support layer 250 (having two major surfaces 252 and 254). More specifically, the first major surfaces 242 and 262 form the outer adhesive surfaces of double-sided tape 210; the second major surface 244 of the first adhesive free-standing film 240 is adjacent the first major surface 252 of the foam support layer 250; and the second major surface 264 of the second adhesive free-standing film 260 is adjacent the second major surface 254 of the foam support layer 250.

The second curable adhesive free-standing film comprises: a′) a film-forming polymer or oligomer; b′) a species comprising unsaturated free-radically polymerizable groups, which may be a′) or a species other than a′); and c′) a transition metal cation. The components of the first and second curable adhesive free-standing films may be the same or different. In certain embodiments, b′) is a′) in the curable adhesive free-standing film. In certain embodiments, b′) is a species other than a′), wherein a′) does not comprise unsaturated free-radically polymerizable groups.

In one embodiment of FIG. 2, the first curable adhesive free-standing film 240 is borne on a first major surface 252 of the curable foam support layer 250, and the second curable adhesive free-standing film 260 is borne on a second major surface 254 of the curable foam support layer 250. In another embodiment of FIG. 2, the first curable adhesive free-standing film 240 is directly bound to a first major surface 252 of the curable foam support layer 250 and the second curable adhesive free-standing film 260 is directly bound to a second major surface 254 of the curable foam support layer 250.

Such adhesive tapes are used with an activator, which includes an oxidizing agent and initiates cure of the curable adhesive films and curable foam support layers upon contact between the activator and the curable adhesive films. Typically, the oxidizing agent of the activator migrates into the curable adhesive film and the curable foam support layer, thereby initiating cure of both the curable adhesive film and the curable foam support layer.

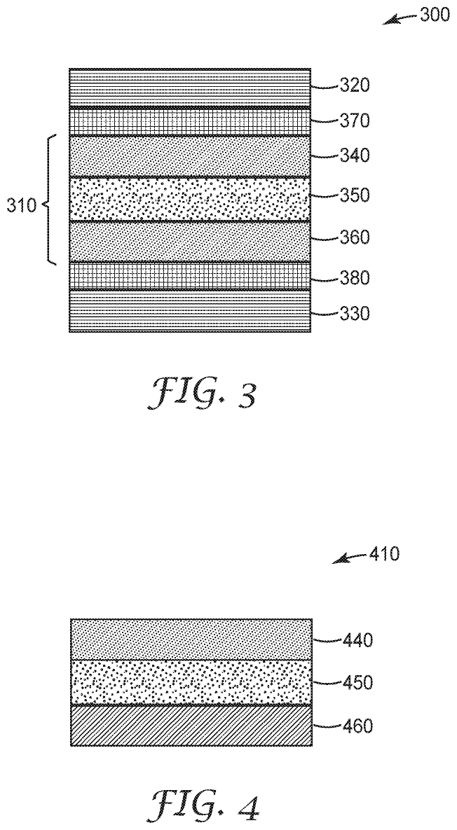

During use, the activator is typically applied to a substrate, allowed to dry, and the curable adhesive free-standing film of the tape is applied to the activator-coated substrate. With reference to FIG. 3 (not to scale), in one embodiment, construction 300 includes tape 310 and substrates 320 and 330. The substrates may be of any suitable material. Suitable substrate materials may include metals, such as aluminum, titanium, steel, and the like. Suitable substrate materials may include polymeric materials, such as polyolefins, polyethylenes, polypropylenes, polystyrenes, poly(meth)acrylates, polyurethanes, natural or synthetic rubbers, polydienes, and the like. Suitable substrate materials may include natural materials, such as wood, stone, and the like, or derivatives, such as composite board or concrete, and the like. Suitable substrate materials may include glass or ceramic materials. If two substrates are bonded together using the adhesive systems of the present disclosure, they are independently selected.

As shown in FIG. 3, an activator according to the present disclosure is applied to first substrate 320 and allowed to dry to form activator layer 370 adjacent to first substrate 320. Similarly, an activator according to the present disclosure is applied to second substrate 330 and allowed to dry to form activator layer 380 adjacent to second substrate 330. The activators used to form activator layers 370 and 380 may be the same or different. A double-sided tape 310, according to one embodiment of the present disclosure, that includes curable adhesive free-standing films 340 and 360 adjacent to a single curable foam support layer 350 is applied to activator layers 370 and 380 such that the curable adhesive free-standing films 340 and 360 are in contact with the activator layers 370 and 380, respectively. In some embodiments during use, the assembly is held by external forces, e.g., a clamp, until the curable adhesive films become cured, however, in other embodiments the tackiness of the tape alone holds the assembly until cure. The tape cures to form cured structural adhesive layers from curable adhesive free-standing films 340 and 360, which are adjacent to activator layers 370 and 380, and cured foam support layer 350. Activator layers 370 and 380 may be cured or simply dried in the final constructions, which include two substrates bonded together by a double-sided tape using structural adhesive bonds.

Herein, “curable” means crosslinkable upon contact with the activator. Both the foam support layer and adhesive free-standing film are curable in that they are crosslinkable; however, they may be crosslinkable via the same or a different mechanism.

The curable adhesive free-standing film includes a film-forming polymer or oligomer. It also includes a crosslinkable species (i.e., crosslinker). Such crosslinkable species may be a species comprising unsaturated free-radically polymerizable groups, which may be the film-forming polymer or oligomer or a species other than the film-forming polymer or oligomer. That is, the crosslinkable species may be the film-forming polymer or oligomer if it includes unsaturated free-radically polymerizable groups. Alternatively, the crosslinkable species may be distinct from the film-forming polymer or oligomer.

In certain embodiments, the curable foam support layer includes a base polymer or oligomer and a crosslinker within the curable foam support layer (using an analogous mechanism to that of the curable adhesive free-standing film). Such crosslinker may be a species comprising unsaturated free-radically polymerizable groups, which may be a film-forming polymer or oligomer or a species other than a film-forming polymer or oligomer. That is, the base polymer or oligomer of the curable foam support layer may be the same as the film-forming polymer or oligomer of the curable adhesive free-standing film, which may or may not include unsaturated free-radically polymerizable groups.

If the base polymer or oligomer of the curable foam support layer does not include unsaturated free-radically polymerizable groups, such groups may be provided by a distinct species within the curable foam support layer (as described herein for the curable adhesive free-standing film), or they may be provided by a species that migrates into the curable foam support layer. Thus, in certain embodiments, the curable foam support layer includes a base polymer or oligomer that is receptive to receiving a crosslinker that is migratable into the curable foam support layer. Typically, in such embodiments, the crosslinker migrates from the curable adhesive free-standing film.

The crosslinker of the curable foam support layer may be the same or different than the crosslinker of the curable adhesive free-standing film (i.e., the species comprising unsaturated free-radically polymerizable groups). In certain embodiments, the crosslinker of the curable foam support layer is the same as the species comprising unsaturated free-radically polymerizable groups of the curable adhesive free-standing film. In certain embodiments, the crosslinker of the curable foam support layer is the species comprising unsaturated free-radically polymerizable groups of the curable adhesive free-standing film that migrates into the curable support layer.

Thus, in the present disclosure, the curable free-standing film includes crosslinkable species within it prior to cure initiated by the activator, whereas the curable foam support layer may include crosslinkable species within it prior to cure initiated by the activator, or the curable foam support layer may be receptive to receiving migratable crosslinkable species prior to cure initiated by the activator. In this context, this crosslinkable species and the curing process is distinct from any crosslinker, such as a crosslinking monomer, used during preparation, including crosslinking, of the adhesive free-standing film and/or curable foam support layer prior to formation of a tape.

The curable foam support layer of the tapes of the present disclosure is in the form of a foam that may be a closed cell, open cell, syntactic, or non-syntactic foam. Such foams can be made using chemical foaming agents, physical foaming agents, mechanical foaming processes, etc. In certain embodiments, the curable foam support layer includes a foaming agent and the same components as the curable adhesive free-standing film.

Preferably, the tape is a multilayer tape. In certain embodiments, the tapes of the present disclosure may include one or more curable free-standing adhesive films (having two major surfaces), and one or more curable foam support layers (having two major surfaces). In certain embodiments, a multilayer tape of the present disclosure also includes one or more barrier film support layers (having two major surfaces), one or more conventional adhesive layers (having two major surfaces) that include an adhesive that is not curable upon contact with the activator, as well as a tape backing material and release liners that are commonly used in multilayer tapes.

For example, a double-sided tape of the present disclosure may include only one curable adhesive free-standing film and only one curable foam support layer but may include a secondary adhesive layer that is not curable upon contact with the activator.

As shown in FIG. 4 (not to scale), an exemplary tape 410 includes a curable adhesive free-standing film 440, and a secondary adhesive layer 460, which may be any of a variety of conventional adhesives (e.g., pressure sensitive adhesives) that are not curable upon contact with the activator, each of which are adjacent to opposite surfaces of a curable foam support layer 450. Exemplary conventional adhesives include pressure sensitive adhesives that are tacky and bond instantly when pressure is applied, thermoplastic adhesives that bond with applied heat and pressure and can be reversible with heat, or thermosetting adhesives that bond when subjected to heat and pressure for a predetermined period of time so as to cause some irreversible chemical reaction to occur. In some embodiments secondary adhesive layer 460 is a conventional pressure sensitive adhesive, which achieves lower adhesion strength than the curable adhesive free-standing film 440 applied to an activator on a substrate.

One or more barrier film support layers (i.e., barrier layers) may be used in multilayer tapes of the present disclosure to provide a barrier, for example, to migration of the crosslinkable species, for example. For example, a tape of the type described in FIG. 1 can further include a barrier film support layer adjacent the major surface of the curable foam support layer opposite that of the curable adhesive free-standing film, such that a 3-layer tape including curable adhesive/curable foam/barrier is formed.

In another example, a tape of the type described in FIG. 2 can further include a barrier film support layer disposed between the curable foam support layer and one of the curable adhesive free-standing films. In this embodiment, a first curable adhesive free-standing film is adjacent a curable foam support layer, which is adjacent a barrier film support layer, which is adjacent a second curable adhesive free-standing film, such that a 4-layer tape including curable adhesive/curable foam/barrier/curable adhesive is formed. Alternatively stated, the first curable adhesive free-standing film is adjacent the curable foam support layer, the barrier film support layer is adjacent a surface of the curable foam support layer opposite the first curable adhesive free-standing film, and the second curable adhesive free-standing film is adjacent a surface of the barrier film support layer opposite the curable foam support layer.

In another example, a multilayer tape can be prepared from two tapes of the type described in FIG. 1 with a barrier film support layer disposed between the curable foam layers of the two tapes, such that a 5-layer tape including curable adhesive/curable foam/barrier/curable foam/curable adhesive is formed.

In yet another example, a multilayer tape can be prepared from two double-sided tapes of the type shown in FIG. 2 with a barrier film support layer disposed between the two tapes, such that a 7-layer tape including curable adhesive/curable foam/curable adhesive/barrier/curable adhesive/curable foam/curable adhesive is formed. That is, in such embodiment, a first curable adhesive free-standing film, a first curable foam support layer, a second curable adhesive free-standing film, a barrier film support layer, a third curable adhesive free-standing film, a second curable foam support layer, and a fourth curable adhesive free-standing film are sequentially stacked.

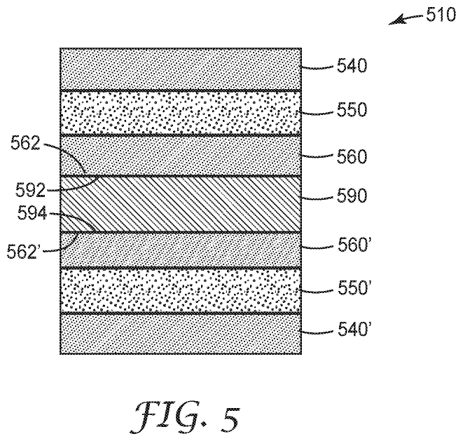

More specifically, as shown in FIG. 5 (not to scale), the tape 510 includes a first curable adhesive free-standing film 540, and a second curable adhesive free-standing film 560, each of which are adjacent to the opposite major surfaces of a first curable foam support layer 550. The tape 510 also includes a third curable adhesive free-standing film 540′, and a fourth curable adhesive free-standing film 560′, each of which are adjacent to the opposite major surfaces of a second curable foam support layer 550′. The curable adhesive free-standing film 560 has a surface 562 that is adjacent a first surface 592 of barrier film support layer 590, and the curable adhesive free-standing film 560′ has a surface 562′ that is adjacent a second surface 594 of barrier film support layer 590. Barrier film support layer 590 prevents migration of crosslinkable species across it. Thus, different curing mechanisms and curable components can be used on either side of the barrier layer (i.e., within layers 540/550/560 as compared to layers 540′/550′/560′).

Multilayer tapes of the present disclosure may include two or more curable adhesive free-standing films having components that are the same or different (i.e., they are independently selected). Multilayer tapes of the present disclosure may include two or more curable foam support layers having components that are the same or different (i.e., they are independently selected). Multilayer tapes of the present disclosure may include two or more barrier film support layers having components that are the same or different (i.e., they are independently selected). Constructions of the present disclosure may include two or more activator layers having components that are the same or different (i.e., they are independently selected).

The curable or cured adhesive free-standing adhesive films may be of any suitable thickness. In some embodiments, the thickness is at least 20 micrometers, at least 25 micrometers, at least 50 micrometers, at least 100 micrometers, at least 200 micrometers, at least 250 micrometers, at least 300 micrometers, or at least 350 micrometers. In some embodiments, the thickness is not more than 2000 micrometers, not more than 1000 micrometers, or not more than 500 micrometers.

The curable or cured foam support layers may be of any suitable thickness. In some embodiments, the thickness is at least 20 micrometers, at least 25 micrometers, at least 50 micrometers, at least 100 micrometers, at least 200 micrometers, at least 250 micrometers, at least 300 micrometers, or at least 350 micrometers. In some embodiments, the thickness is not more than 2000 micrometers, not more than 1000 micrometers, or not more than 500 micrometers.

The barrier film support layers may be of any suitable thickness. In some embodiments, the thickness is at least 10 micrometers, at least 15 micrometers, at least 20 micrometers, at least 25 micrometers, or at least 50 micrometers. In some embodiments, the thickness is not more than 2000 micrometers, not more than 1000 micrometers, or not more than 500 micrometers.

The activator layers may be of any suitable thickness. In some embodiments, thickness is at least 1 micrometer, at least 2 micrometers, at least 3 micrometers, at least 4 micrometers, or at least 5 micrometers. In some embodiments, thickness is not more than 20 micrometers, not more than 15 micrometers, or not more than 10 micrometers.

The tapes of the present disclosure preferably have a compliance of at least 0.5 mil (12.7 micrometers) per the Lang Test described in the Examples Section.

### Curable Adhesive Free-Standing Film

The curable adhesive free-standing films (i.e., curable adhesive films) of the tapes of the present disclosure include a film-forming polymer or oligomer, a species comprising unsaturated free-radically polymerizable groups, which may be the film-forming polymer or oligomer (i.e., a reactive polymer or oligomer comprising unsaturated free-radically polymerizable groups) or a species other than the film-forming polymer or oligomer, and a transition metal cation.

In some embodiments, the unsaturated free-radically polymerizable groups are selected from ethylenically unsaturated groups, including vinyl-containing groups such as (meth)acrylate groups.

The curable adhesive films are typically room temperature solids.

In some embodiments, the curable free-standing films comprise a blend of a reactive polymer or oligomer comprising unsaturated free-radically polymerizable groups, which are typically pendant groups, and a transition metal cation. In some embodiments, the curable free-standing films comprise a blend of a film-forming polymer or oligomer, a reactive species comprising unsaturated free-radically polymerizable groups, and a transition metal cation. In certain embodiments, the curable free-standing films also include a redox accelerator.

In some embodiments, the curable adhesive film has an outer surface, i.e., a substrate-facing surface, which includes embossed air bleed channels capable of aiding in escape of air during application of the outer surface to a substrate. The channels, and methods of their production, may be as taught in U.S. Pat. No. 6,655,281 (Jordan et al.). Such channels fulfil a unique purpose in the use of the articles of the present disclosure. By allowing escape of trapped air bubbles, air bleed channels may help to improve contact with an activator or second film which initiates cure of the curable adhesive film. Where an adhesive film or tape has one embossed face and one that is not embossed, the non-embossed face may be placed on a first substrate and the second substrate may then be brought into contact with the embossed face. This approach may be particularly useful where two stiff substrates are to be joined, since it allows air bleed and adaptability to uneven surfaces despite the inflexibility of the substrates.

The curable adhesive film may be made using conventional techniques such as solution coating onto a web. In preferred embodiments, the curable adhesive film is hot melt processable and is made in a hot melt process. Hot melt processing, such as hot melt blending or hot melt extrusion, may be accomplished by any suitable means, including those disclosed in U.S. Pat. Pub. No. 2013/0184394 A1 (Satrijo et al.).

Film-Forming Polymer or Oligomer In some embodiments, the film-forming polymer or oligomer is a poly(meth)acrylate polymer or oligomer. Other examples of film-forming polymers or oligomers include: aromatic or aliphatic polyurethanes, including those polymers made with aliphatic or aromatic diols, polyamides, saturated and unsaturated polyesters, such as polybutylene terephthalate, polyethylene terephthalate, polyglycolic acid, polylactic acid, poly-2-hydroxy butyrate, polycaprolactone, and combinations containing maleic acid repeating units; polyethers, such as polyacetal and its copolymers, polyphenylene oxide, polyetherketone, polyetheretherketone; natural and synthetic rubbers, such as polyisoprene, polychloroprene, nitrile rubber, butadiene-based rubbers; alkyds; phenolic resins, such as novolacs and resoles; amino resins, such as urea-formaldehyde resins, melamine-formaldehyde resins, and melamine-urea copolymer resins; epoxies, such as those made from Bisphenol A or adducts using telechelic amino resins capped with oxirane functional groups; etc. In some embodiments, the film-forming polymer or oligomer is a (meth)acrylate functional polymer, such as that made by adding (meth)acrylate end groups to polyester, polyurethane, polybutadiene, or polyether polymers.

In some embodiments, the film-forming polymer or oligomer of the curable adhesive free-standing film is a poly(meth)acrylate polymer or oligomer.

In certain embodiments, the curable adhesive films are pressure sensitive adhesives before cure upon contact with an activator. As such, they are capable of maintaining substrates in position even prior to cure, under shop or factory conditions, without clamps or other supports. Preferred such pressure sensitive adhesives include: a first (meth)acrylate copolymer comprising from 0.1 weight percent to 12 weight percent of (meth)acrylic acid monomer units, based on the weight of the first (meth)acrylate copolymer; and a second (meth)acrylate copolymer comprising from 15 weight percent to 40 weight percent of (meth)acrylic acid monomer units, based on the weight of the second (meth)acrylate copolymer.

In such embodiments, wherein the curable adhesive films are pressure sensitive adhesives, the first (meth)acrylate copolymer and/or the second (meth)acrylate copolymer, preferably the first (meth)acrylate copolymer and the second (meth)acrylate copolymer, comprise, as main monomer units, linear or branched alkyl (meth)acrylate ester monomer units selected from the group consisting of methyl (meth)acrylate, ethyl (meth)acrylate, n-propyl (meth)acrylate, isopropyl (meth)acrylate, n-butyl acrylate, isobutyl acrylate, tert-butyl (meth)acrylate, n-pentyl (meth)acrylate, iso-pentyl (meth)acrylate, n-hexyl (meth)acrylate, iso-hexyl (meth)acrylate, cyclohexyl (meth)acrylate, phenyl (meth)acrylate, octyl (meth)acrylate, iso-octyl (meth)acrylate, 2-octyl(meth)acrylate, 2-ethylhexyl (meth)acrylate, decyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, 2-propylheptyl (meth)acrylate, stearyl (meth)acrylate, isobornyl (meth)acrylate, benzyl (meth)acrylate, nonyl (meth)acrylate, isophoryl (meth)acrylate, and any combinations or mixtures thereof.

In an exemplary embodiment, the first (meth)acrylate copolymer and/or the second (meth)acrylate copolymer, preferably the first (meth)acrylate copolymer and the second (meth)acrylate copolymer, comprise, as main monomer units, linear or branched alkyl (meth)acrylate ester monomer units selected from the group consisting of 2-ethylhexyl (meth)acrylate, 2-propylheptyl (meth)acrylate, iso-octyl (meth)acrylate, and any combinations or mixtures thereof. In still another exemplary embodiment, the first (meth)acrylate copolymer and/or the second (meth)acrylate copolymer, preferably the first (meth)acrylate copolymer and the second (meth)acrylate copolymer, comprise 2-ethylhexyl (meth)acrylate monomers, as main monomer units.

In certain embodiments, the first (meth)acrylate copolymer for use herein has a Tg of no greater than 0° C. and the second (meth)acrylate copolymer for use herein has a Tg of greater than 0° C. In certain embodiments, the second (meth)acrylate copolymer has a Tg of no greater than 100° C., no greater than 80° C., no greater than 60° C., no greater than 50° C., no greater than 45° C., or even no greater than 40° C.

In certain embodiments, the first (meth)acrylate copolymer has a Tg of −70° C. to 0° C., −70° C. to −10° C., −60° C. to −10° C., −60° C. to −20° C., −60° C. to −30° C., −55° C. to −35° C., or −50° C. to −40° C. In certain embodiments, the second (meth)acrylate copolymer has a Tg of 2° C. to 100° C., 2° C. to 80° C., 2° C. to 60° C., 2° C. to 50° C., 2° C. to 45° C., 5° C. to 45° C., 5° C. to 40° C., 5° C. to 35° C., or 10° C. to 30° C.

In certain embodiments, the pressure sensitive adhesive composition of the curable adhesive films of the present disclosure comprises from 65 to 99 weight percent, from 70 to 95 weight percent, from 75 to 95 weight percent, from 75 to 90 weight percent, or even from 75 to 85 weight percent, of the first (meth)acrylate copolymer, and wherein the weight percentages are based on the total weight of the pressure sensitive adhesive composition.

In certain embodiments, the pressure sensitive adhesive composition of the curable adhesive films of the present disclosure comprises from 1 to 35 weight percent, from 1 to 30 weight percent, from 2 to 25 weight percent, from 3 to 25 weight percent, from 3 to 20 weight percent, from 4 to 20 weight percent, or even from 4 to 15 weight percent, of the second (meth)acrylate copolymer, and wherein the weight percentages are based on the total weight of the pressure sensitive adhesive composition.

Exemplary pressure sensitive adhesive compositions of the curable adhesive films are described in U.S. Pat. Appl. Pub. No. 2021/0102099 (Unverhau et al.).

Various combinations of film-forming polymers or oligomers may be used in the curable adhesive free-standing films of the present disclosure.

### Unsaturated Free-Radically Polymerizable Group

The curable adhesive free-standing films include a species comprising unsaturated free-radically polymerizable groups, which may be the film-forming polymer or oligomer (i.e., a reactive polymer or oligomer comprising unsaturated free-radically polymerizable groups) or a species other than the film-forming polymer or oligomer.

In some embodiments, the unsaturated free-radically polymerizable groups are selected from ethylenically unsaturated groups, including vinyl-containing groups such as (meth)acrylate groups.

In some embodiments, the unsaturated free-radically polymerizable groups are part of a crosslinker (i.e., crosslinkable species) distinct from the film-forming polymer or oligomer. Such crosslinkers include two or more, preferably three or more, unsaturated free-radically polymerizable groups, including vinyl-containing groups, such as (meth)acrylate groups. In some embodiments, the crosslinker is a crosslinking monomer. In some embodiments, the crosslinker is an oligomer.

Exemplary crosslinkers include trimethylolpropane triacrylate (TMPTA), ethoxy trimethylolpropane triacrylate, propoxy glycerol triacrylate, pentaerythritol triacrylate, bistrimethylolpropane tetraacrylate, pentaerythritol tetraacrylate, ethoxy pentaerythritol tetraacrylate, trimethylolpropane trimethacrylate, ethoxy pentaerythritol triacrylate, ditrimethylolpropane tetraacrylate, or combinations thereof. Other exemplary crosslinkers include multifunctional polyol derivatives. For example, acrylic acid or methacrylic acid esters of selected polyol in which at least two are esterified can be used as crosslinkers. Exemplary such crosslinkers are ethylene glycol diacrylate, diethylene glycol diacrylate, glycerol diacrylate, glycerol triacrylate, ethylene dimethacrylate, 1,3-propanediol dimethacrylate, 1,2,4-butanetriol trimethacrylate, pentaerythritol tri- and tetra-acrylate and methacrylate, trimethylolpropane triacrylate, hexane diol diacrylate, tetraethylene glycol diacrylate, neopentyl glycol diacrylate, etc.

### Transition Metal Cation

The curable adhesive film additionally comprises a transition metal cation. Examples of suitable transition metal cations include molybdenum, titanium, vanadium, chromium, manganese, iron, cobalt, nickel, copper, or zinc. In some embodiments, the transition metal cation is a copper cation, such as Cu(II), such as may be found in copper(II) acetate monohydrate and copper (II) naphthenate. In some embodiments, the transition metal cation is an iron cation, such as Fe(II) or Fe(III), such as may be found in Black 11 (Fe₃O₄ or FeO—Fe₂O₃), Red 102 (Fe₂O₃), or Yellow 42 (Fe₂O₃·H₂O).

Useful transition metal complexes are described in International Publication No. WO 2018/215889 (Townsend et al.), and have the general formula: [MLₚ]ⁿ⁺A⁻, wherein M represents a transition metal capable of participating in a redox cycle with an oxidizing agent and a reducing agent. Useful transition metals, M, may include the catalytically active valent states of Cu, Fe, Ru, Cr, Mo, Pd, Ni, Pt, Mn, Rh, Re, Co, V, Au, Nb, and Ag. Preferred, low valent transition metals include Cu(II), Fe(II), Ru(II), and Co(II). Other valent states of these metals may be used, and the active low valent state generated in situ.

In such exemplary complexes of the formula [MLₚ]ⁿ⁺A⁻, L represents a ligand. The ligand, L, may be used to solubilize the transition metal salts in a suitable solvent and adjust the redox potential of the transition metal for appropriate reactivity and selectivity. The ligands can direct the transition metal complex to undergo a desired one-electron transfer process, rather than a two-electron process such as oxidative addition/reductive elimination. The ligands may further enhance the stability of the complexes in the presence of different monomers and solvents or at different temperatures. Acidic monomers and monomers that strongly complex transition metals may still be efficiently polymerized by appropriate selection of ligands.

Useful ligands may include those having one or more nitrogen, oxygen, phosphorus, and/or sulfur atoms which can coordinate to the transition metal through a sigma-bond, ligands containing two or more carbon atoms which can coordinate to the transition metal through a pi-bond, etc.

Such ligands may be monodentate or polydentate compounds, preferably containing up to about carbon atoms and up to 10 heteroatoms selected from aluminum, boron, nitrogen, sulfur, non-peroxidic oxygen, phosphorus, arsenic, selenium, antimony, and tellurium, where upon addition to the metal atom, following loss of zero, one, or two hydrogens, the polydentate compounds preferably forming with the metal, Mⁿ⁺, a 4-, 5-, or 6-membered saturated or unsaturated ring. Examples of suitable monodentate ligands are carbon monoxide; alcohols such as ethanol, butanol, and phenol; pyridine, nitrosonium (i.e., NOW); compounds of Group 15 elements such as ammonia, phosphine, trimethylamine, trimethylphosphine, tributylphosphine, triphenylamine, triphenylphosphine, triphenylarsine, or tributyl phosphite; nitriles such as acetonitrile or benzonitrile; isonitriles such as phenylisonitrile or butylisonitrile; carbene groups such as ethoxymethylcarbene or dithiomethoxycarbene; alkylidenes such as methylidene or ethylidene.

Exemplary suitable polydentate compounds or groups include dipyridyl; 1,2-bis(diphenyl-phosphino)ethane; 1,2-bis(diphenylarsino)ethane; bis(diphenylphosphino)methane; polyamines such as ethylenediamine, propylenediamine, tetramethylethylenediamine, hexamethyl tris-aminoethylamine, diethylenetriamine, 1,3-diisocyanopropane, and hydridotripyrazolylborate; hydroxycarboxylic acids such as glycolic acid, lactic acid, salicylic acid; polyhydric phenols such as catechol and 2,2′-dihydroxybiphenyl; hydroxyamines such as ethanolamine, propanolamine, and 2-aminophenol; dithiocarbamates such as diethyldithiocarbamate, dibenzyldithiocarbamate; xanthates such as ethyl xanthate, phenyl xanthate; the dithiolenes such as bis(perfluoromethyl)-1,2-dithiolene; aminocarboxylic acids such as alanine, glycine and o-aminobenzoic acid; dicarboxylic diamines as oxalamide, biuret; diketones such as 2,4-pentanedione; hydroxyketones such as 2-hydroxyacetophenone; α-hydroxyoximes such as salicylaldoxime; ketoximes such as benzil oxime; 1,10-phenanthroline; porphyrins; cryptands and crown ethers such as 18-crown-6 ether; and glyoximes such as dimethylglyoxime.

Other suitable ligands that can coordinate to the transition metal through a sigma bond are the inorganic groups such as, for example, F⁻, OH⁻, Cl⁻, Br⁻, I⁻, and hydride, and organic groups such as, for example, CN⁻, SCN⁻, acetoxy, formyloxy, and benzoyloxy. The ligand can also be a unit of a polymer, for example, the amino group in poly(ethylenimine); the phosphino group in poly(4-vinylphenyldiphenylphosphine), the carboxylic acid group in poly(acrylic acid), and the isonitrile group in poly(4-vinylphenylisonitrile).

Useful ligands containing two or more carbon atoms that can coordinate to the transition metal through a pi-bond are provided by any monomeric or polymeric compound having an accessible unsaturated group, e.g., an ethylenic group, acetylenic group, or aromatic group which has accessible pi-electrons regardless of the total molecular weight of the compound.

Exemplary pi-bond ligands include the linear and cyclic ethylenic and acetylenic compounds having less than 100 carbon atoms (when monomeric), preferably having less than 60 carbon atoms, and from zero to 10 heteroatoms selected from nitrogen, sulfur, non-peroxidic oxygen, phosphorous, arsenic, selenium, boron, aluminum, antimony, tellurium, silicon, germanium, and tin, the ligands being those such as ethylene, acetylene, propylene, methylacetylene, α-butene, 2-butene, diacetylene, butadiene, 1,2-dimethylacetylene, cyclobutene, pentene, cyclopentene, hexene, cyclohexene, 1,3-cyclohexadiene, cyclopentadiene, 1,4-cyclohexadiene, cycloheptene, 1-octene, 4-octene, 3,4-dimethyl-3-hexene, and 1-decene; η³-allyl, η³-pentenyl, norbomadiene, η⁵-cyclohexadienyl, cycloheptatriene, cyclooctatetraene, and substituted and unsubstituted carbocyclic and heterocyclic aromatic ligands having up to 25 rings and up to 100 carbon atoms and up to 10 hetero atoms selected from nitrogen, sulfur, non-peroxidic oxygen, phosphorus, arsenic, selenium, boron, aluminum, antimony, tellurium, silicon, germanium, and tin, such as, for example, η⁵-cyclopentadienyl, benzene, mesitylene, toluene, xylene, tetramethylbenzene, hexamethylbenzene, fluorene, naphthalene, anthracene, chrysene, pyrene, η⁷-cycloheptatrienyl, triphenylmethane, paracyclophane, 1,4-diphenylbutane, η⁵-pyrrolo, η⁵-thiophene, η⁵-furan, pyridine, γ-picoline, quinaldine, benzopyran, thiochrome, benzoxazine, indole, acridine, carbazole, triphenylene, silabenzene, arsabenzene, stibabenzene, 2,4,6-triphenylphosphabenzene, η⁵-selenophene, dibenzostannepine, η⁵-tellurophene, phenothiazine, selenanthrene, phenoxaphosphine, phenarsazine, phenatellurazine, η⁵-methylcyclopentadienyl, η⁵-pentamethylcyclopentadienyl, and 1-phenylborabenzene. Other suitable aromatic compounds can be found by consulting any of many chemical handbooks.

Preferred ligands include unsubstituted and substituted pyridines and bipyridines, tertiary amines, including polydentate amines such as N,N,N′,N′-tetramethylethylenediamine and tris(N,N-dimethylamino-ethyl)amine, acetonitrile, phosphites (e.g., (CH₃O)₃P), 1,10-phenanthroline, porphyrin, cryptands and crown ethers (e.g., 18-crown-6 ether). Most preferred ligands are polydentate amines, bipyridine, and phosphites. Ligands and ligand-metal complexes useful in the initiator systems of the present disclosure are described in Matyjaszewski and Xia, Chemical Reviews, 2001, vol. 101, pp. 2921-2990.

In such exemplary complexes of the formula [MLₚ]ⁿ⁺A⁻, A⁻ represents an anion. Exemplary useful anions, A⁻, include halide (e.g., chloride, bromide, fluoride), alkoxy groups having from 1 to 6 carbon atoms (i.e., C₁-C₆ alkoxy), nitrate, sulfate, phosphate, biphosphate, hexafluorophosphate, triflate, methanesulfonate, arenesulfonate, cyanide, alkanecarboxylates (e.g., acetate), and arenecarboxylates (e.g., benzenecarboxylate).

In such exemplary complexes of the formula [MLₚ]ⁿ⁺A⁻, n represents the formal charge on the transition metal having a whole number value of 1 to 7, preferably 1 to 3, and p is the number of ligands on the transition metal having a number value of 1 to 9, preferably 1 to 2.

### Redox Accelerator

In some embodiments, the curable adhesive free-standing film additionally includes a redox accelerator, such as a quaternary amine. In other embodiments the redox accelerator may be chosen from organic or inorganic chloride ion containing compounds such as amine hydrochlorides or sodium chloride.

For example, dimethyl benzyl aniline chloride (DMBAC), a quaternary ammonium salt, is an efficient component of a redox couple for radical initiation of acrylic or vinyl polymerizations in solvent.

Exemplary quaternary ammonium salts may be represented by the following formula:

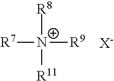

wherein R⁷, R⁸, R⁹, and R¹¹, which may be the same or different, are hydrocarbyl, hydrocarbylaryl, aryl or a substituted derivative thereof. X is Cl, Br, or F, or a soft anion, such as SbF, BF, or PF.

Phosphonium salts may also be useful as a redox accelerator. Exemplary phosphonium salts may be represented by the following formula:

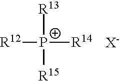

wherein R¹², R³, R¹⁴, and R¹⁵ which may be the same or different, are hydrocarbyl, hydrocarbylaryl, aryl or a substituted derivative thereof X is Cl, Br, I, or F, or a soft anion,
such as SbF, BF, or PF. Desirably, R¹², R¹³ and R¹⁴ are each phenyl or C1-C5 alkyl.
   Desirably, the phosphonium salt used is selected from allyltriphenylphosphonium bromide (ATPB), 2-(ethoxycarbony)ethyl-triphenylphosphonium bromide, I-ethoxycarbonylethyl triphenylphosphonium bromide, 4-ethoxycarbonylbutyl triphenylphosphonium bromide, carbethoxymethyl triphenylphosphonium bromide, or methyltriphenylphosphonium bromide.

Various combinations of redox accelerators may be used if desired.

In certain embodiments, the redox accelerator is used in an amount of at least 025 weight percent, and typically up to 4 weight percent, based on the weight of the curable adhesive free-standing film (e.g., a combination of a film forming polymer, transition metal compound, crosslinker, and redox accelerator).

The redox accelerator and transition metal cation are involved in the redox reaction initiated by the oxidizing agent in the activator that causes crosslinking of the crosslinkable species. For example, it is believed that the oxidizing agent (e.g., tert-butylperoxy-2-ethylhexyl carbonate (TBEC)) oxidizes the transition metal cation (e.g., Cu(I) to Cu(II)) forming radicals (e.g., tert-butoxy radicals) that initiate crosslinking of the crosslinkable species (typically catalytically) thereby forming a crosslinked network. While not being bound by theory, in this example it is believed that the redox accelerator serves as a reducing agent of the initially provided Cu(II) cation to Cu(I).

### Curable Foam Support Layer

In certain embodiments, the curable foam support layer comprises a base polymer or oligomer, which may be the same or different than the film-forming polymer or oligomer of the curable adhesive free-standing film. In certain embodiments, the curable foam support layer comprises a base polymer or oligomer, which is the same as the film-forming polymer or oligomer of the curable adhesive free-standing film.

In certain embodiments, the curable foam support layer includes a crosslinker mixed therein. In certain embodiments, the system includes a crosslinker that is migratable into the curable foam support layer (from the curable adhesive free-standing film). Exemplary crosslinkers are those described herein for the curable adhesive free-standing films.

In certain embodiments, the curable foam support layer further includes a polymer modulus modifier to provide a desirable modulus. In certain embodiments, the polymer modulus modifier comprises a polymer having a Tg of no greater than 100° C., no greater than 90° C., no greater than 80° C., no greater than 70° C., no greater than 60° C., no greater than 50° C., or no greater than 40° C. In certain embodiments, the polymer modulus modifier comprises a polyvinyl acetal resin, particularly polyvinyl butyral (PVB). In certain embodiments, the polymer modulus modifier comprises a high acid polymer.

In some embodiments, the curable foam support layer includes a transition metal cation as described for the curable adhesive free-standing film. In some embodiments, the curable foam support layer also includes a redox accelerator as described for the curable adhesive free-standing film.

### Base Polymer or Oligomer

The curable foam support layer may be a closed cell, open cell, syntactic, or non-syntactic foam. The foam may be made using chemical foaming agents, physical foaming agents, mechanical mechanisms, etc., as is known in the art.

In some embodiments, the base polymer or oligomer includes film-forming polymers or oligomers such as: aromatic or aliphatic polyurethanes, including those polymers made with aliphatic or aromatic diols, polyamides, saturated and unsaturated polyesters, such as polybutylene terephthalate, polyethylene terephthalate, polyglycolic acid, polylactic acid, poly-2-hydroxy butyrate, polycaprolactone, and combinations containing maleic acid repeating units; polyethers, such as polyacetal and its copolymers, polyphenylene oxide, polyether ketone, polyetheretherketone; natural and synthetic rubbers, such as polyisoprene, polychloroprene, nitrile rubber, butadiene-based rubbers; alkyds; phenolic resins, such as novolacs and resoles; amino resins, such as urea-formaldehyde resins, melamine-formaldehyde resins, and melamine-urea copolymer resins; epoxies, such as those made from Bisphenol A or adducts using telechelic amino resins capped with oxirane functional groups; etc. In some embodiments, the film-forming polymer or oligomer is a (meth)acrylate functional polymer, such as that made by adding (meth)acrylate end groups to polyester, polyurethane, polybutadiene, or polyether polymers.

In some embodiments, the base polymer or oligomer of the curable foam support layer is a poly(meth)acrylate polymer or oligomer. In certain embodiments, the base polymer of the curable foam support layer is a silicone polymer. Acrylate and silicone foams are useful due to their ultraviolet light stability, conformability, and ability to distribute stress. The acrylate polymer can be, for example, an acrylic acid ester of a non-tertiary alcohol having from 1 to 18 carbon atoms. In some embodiments, the acrylic acid ester includes a carbon-to-carbon chain having 4 to 12 carbon atoms and terminates at the hydroxyl oxygen atom, the chain containing at least half of the total number of carbon atoms in the molecule.

Certain useful acrylic acid esters are polymerizable to a tacky, stretchable, and elastic adhesive. Examples of acrylic acid esters of nontertiary alcohols include, but are not limited to, 2-methylbutyl acrylate, isooctyl acrylate, lauryl acrylate, 4-methyl-2-pentyl acrylate, isoamyl acrylate, sec-butyl acrylate, n-butyl acrylate, n-hexyl acrylate, 2-ethylhexyl acrylate, n-octyl acrylate, n-decyl acrylate, isodecyl acrylate, isodecyl methacrylate, and isononyl acrylate. Suitable acrylic acid esters of nontertiary alcohols include, for example, 2-ethylhexyl acrylate and isooctylacrylate.

To enhance the strength of the foam, the acrylic acid ester may be copolymerized with one or more monoethylenically unsaturated monomers that have highly polar groups. Such monoethylenically unsaturated monomer such as acrylic acid, methacrylic acid, itaconic acid, acrylamide, methacrylamide, N-substituted acrylamides (for example, N,N-dimethyl acrylamide), acrylonitrile, methacrylonitrile, hydroxyalkyl acrylates, cyanoethyl acrylate, N-vinylpyrrolidone, N-vinylcaprolactam, and maleic anhydride. In some embodiments, these copolymerizable monomers are used in amounts of less than 20% by weight of the base polymer matrix.

Especially useful are acrylate copolymers comprising at least 6% by weight acrylic acid, and in other embodiments, at least 8% by weight, or at least 10% by weight acrylic acid, each based on the total weight of the monomers in the acrylate copolymer. The adhesive may also include small amounts of other useful copolymerizable monoethylenically unsaturated monomers such as alkyl vinyl ethers, vinylidene chloride, styrene, and vinyltoluene.

In certain embodiments, the base polymer or oligomer of the curable foam support layers include the first (meth)acrylate copolymer comprising from 0.1 weight percent to 12 weight percent of (meth)acrylic acid monomer units, based on the weight of the first (meth)acrylate copolymer, described herein for the pressure sensitive adhesive of the curable free-standing adhesive films. That is, in such embodiments, the base polymer or oligomer of the curable foam support layers, comprise, as main monomer units, linear or branched alkyl (meth)acrylate ester monomer units selected from the group consisting of methyl (meth)acrylate, ethyl (meth)acrylate, n-propyl (meth)acrylate, isopropyl (meth)acrylate, n-butyl acrylate, isobutyl acrylate, tert-butyl (meth)acrylate, n-pentyl (meth)acrylate, iso-pentyl (meth)acrylate, n-hexyl (meth)acrylate, iso-hexyl (meth)acrylate, cyclohexyl (meth)acrylate, phenyl (meth)acrylate, octyl (meth)acrylate, iso-octyl (meth)acrylate, 2-octyl(meth)acrylate, 2-ethylhexyl (meth)acrylate, decyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, 2-propylheptyl (meth)acrylate, stearyl (meth)acrylate, isobornyl (meth)acrylate, benzyl (meth)acrylate, nonyl (meth)acrylate, isophoryl (meth)acrylate, and any combinations or mixtures thereof. In certain embodiments, this (meth)acrylate copolymer has a Tg of no greater than 0° C. In certain embodiments, this (meth)acrylate copolymer has a Tg of −70° C. to 0° C., −70° C. to −10° C., −60° C. to −10° C., −60° C. to −20° C., −60° C. to −30° C., −55° C. to −35° C., or −50° C. to −40° C.

In some embodiments, the base polymer or oligomer of the curable foam support layer is made from a silicone polymer. Suitable silicone polymers can include, for example, an MQ resin containing a resinous core and nonresinous polyorganosiloxane group terminated with a silicon-bonded hydroxyl group; a treated MQ resin, and a polydiorganosiloxane terminated with a condensation reactable group. Such compositions may be used for structural glazing applications, as described in U.S. Pat. No. 8,298,367 (Beger et al.).

Enhancement of the cohesive strength of the curable foam support layer may also be achieved through the use of a crosslinking agent, such as 1,6-hexanediol diacrylate, with a photoactive triazine crosslinking agent such as taught in U.S. Pat. No. 4,330,590 (Vesley) and U.S. Pat. No. 4,329,384 (Vesley et al), or with a heat-activatable crosslinking agent such as a lower-alkoxylated amino formaldehyde condensate having C14 alkyl groups, for example, hexamethoxymethyl melamine or tetramethoxymethyl urea or tetrabutoxymethyl urea. Crosslinking may be achieved by irradiating the composition with electron beam (or “e-beam”) radiation, gamma radiation, or x-ray radiation. This crosslinking occurs in the preparation of the curable foam support layer, which occurs prior to contact with the activator.

The base polymer or oligomer used in the foam can be prepared by any suitable polymerization method. Suitable polymerization methods include, but are not limited to, photopolymerization, thermal polymerization, or ionizing radiation polymerization. These methods can be carried out in solution, emulsion, or bulk without solvent. Bulk polymerization methods are described in U.S. Pat. No. 5,804,610 (Hamer et al.). Optionally, photopolymerizable monomers may be partially polymerized to a viscosity of from 1000 to 40,000 cps to facilitate coating. Alternatively, partial polymerization can be effected by heat. If desired, viscosity can also be adjusted by mixing monomers with a thixotropic agent such as fumed silica.

Photopolymerization can take place in an inert atmosphere such as under a blanket of nitrogen or argon gas. Alternatively, an inert environment can be achieved by temporarily covering the photopolymerizable coating with a plastic film transparent to ultraviolet radiation and irradiating the coating through the film. If the polymerizable coating is not covered during photopolymerization, the permissible oxygen content of the inert atmosphere can be increased by mixing into the photopolymerizable composition an oxidizable tin compound such as disclosed in U.S. Pat. No. 4,303,485 (Levens), which can enable relatively thicker coatings to be polymerized in air.

### Crosslinker

In certain embodiments, the curable foam support layer includes a crosslinker mixed therein. In certain embodiments, the system includes a crosslinker that is migratable into the curable foam support layer (from the curable adhesive free-standing film). Exemplary crosslinkers are those described herein for the curable adhesive free-standing films.

In certain embodiments, the crosslinker is the same or different than the species comprising unsaturated free-radically polymerizable groups of the curable adhesive free-standing film. In certain embodiments, the crosslinker is the same as the species comprising unsaturated free-radically polymerizable groups of the curable adhesive free-standing film. In certain embodiments, the crosslinker is the species comprising unsaturated free-radically polymerizable groups of the curable adhesive free-standing film. That is, in certain embodiments, the crosslinker is the species comprising unsaturated free-radically polymerizable groups of the curable adhesive free-standing film that migrates into the curable support layer.

The crosslinker (i.e., crosslinkable species) that is included within the curable foam support layer and/or migrates into the curable foam support layer, and that is included within the curable adhesive free-standing film, is activated when contact between the curable adhesive film and the activated surface initiates the redox cycle, thereby initiating crosslinking. This crosslinking of the crosslinker results in curing of both the curable adhesive film and the curable foam support layer. It is believed that an interpenetrating crosslinked network is formed in the bulk of the adhesive layers wherein the first network is that formed from the crosslinker and the second network is that from the film-forming polymer or oligomer. This crosslinked network is formed across the boundary between the various layers of the cured tapes (e.g., across the boundary between a cured adhesive free-standing film and a cured foam support layer), which is evidenced by cohesive failure of the cured tapes.

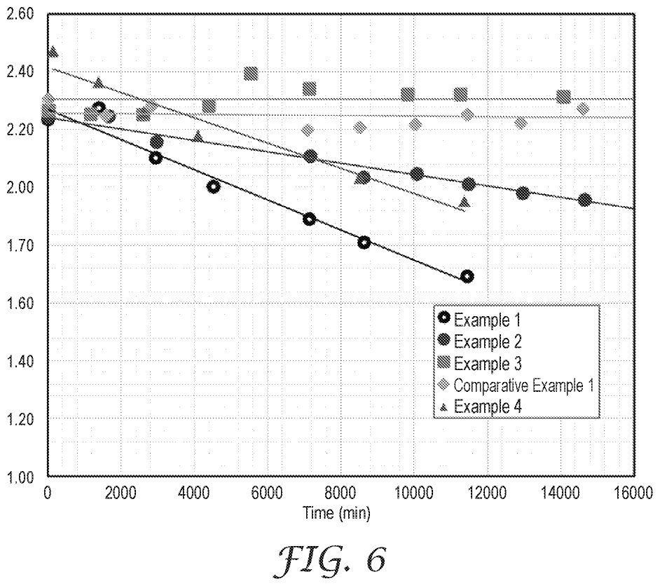

FIG. 6 shows that Examples 1, 2, and 4 in the Examples below have significant migration of crosslinker from the curable adhesive free-standing film into the curable foam support layer. Example 3 was initially prepared with crosslinker in both the curable foam support layer and the curable adhesive free-standing film. Comparative Example 1 shows no substantial migration of crosslinker in FIG. 6, and there is no curable component in the tape support layer. As shown in Table 3, the dynamic shear adhesion is much higher for Examples 1 to 4 than for Comparative Example 1.

### Polymer Modulus Modifier

In certain embodiments, the curable foam support layer further includes a polymer modulus modifier to provide a desirable modulus. In certain embodiments, the polymer modulus modifier comprises a polymer having a Tg of no greater than 100° C., no greater than 90° C., no greater than 80° C., no greater than 70° C., no greater than 60° C., no greater than 50° C., or no greater than 40° C.

In certain embodiments, the polymer modulus modifier comprises a polyvinyl acetal resin, particularly polyvinyl butyral (PVB). In certain embodiments, the polymer modulus modifier comprises a high acid polymer. It is believed the polymer modulus modifier does two things: increases the modulus of the foam; and toughens the system against an applied force.

In certain embodiments, the polyvinyl acetal resin includes polymerized units having the formula:

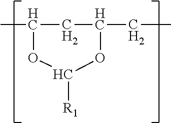

where R₁ is hydrogen or an alkyl group having 1 to 7 carbon atoms (C1-C7).

Polyvinyl acetal resins may be obtained, for example, by reacting polyvinyl alcohol with aldehyde, as known in the art. Polyvinyl alcohol resins are not limited by the production method. For example, those produced by saponifying polyvinyl acetate and the like with alkali, acid, ammonia water, and the like, can be used. Polyvinyl alcohol resins may be either completely saponified or partially saponified. It is preferable to use those having a saponification degree of 80 mol % or more. The polyvinyl alcohol resins may be used singly or in combination of two or more.

Aldehydes used in the production of the polyvinyl acetal resin include formaldehyde (including paraformaldehyde), acetaldehyde (including para-acetaldehyde), propionaldehyde, butyraldehyde, n-octylaldehyde, amylaldehyde, hexylaldehyde, heptylaldehyde, 2-ethylhexylaldehyde, cyclohexylaldehyde, furfural, glyoxal, glutaraldehyde, benzaldehyde, 2-methylbenzaldehyde, 3-methylbenzaldehyde, 4-methylbenzaldehyde, p-hydroxybenzaldehyde, m-hydroxybenzaldehyde, phenylacetaldehyde, beta-phenylpropionaldehyde, and the like. These aldehydes may be used singly or in combination of two or more.

In some embodiments, the alkyl residue of aldehyde includes 1 to 7 carbon atoms. In other embodiments, the alkyl reside of the aldhehyde includes 3 to 7 carbon atoms such as in the case of butylaldehyde, hexylaldehyde, n-octylaldehyde. Of these butyraldehyde, also known as butanal is most commonly utilized. Polyvinyl butyral (“PVB”) resin is commercially available from Kuraray under the trade designation MOWITAL and Solutia under the trade designation BUTVAR.

In some embodiments, the polyvinyl acetal (e.g., butyral) resin has a Tg ranging from 60° C. to 80° C., or 60° C. to 75° C. In some embodiments, the Tg of the polyvinyl acetal (e.g., butyral) resin is at least 65° C., or at least 70° C. When other aldehydes, such as n-octyl aldehyde, are used in the preparation of the polyvinyl acetal resin, the Tg may be less than 65° C., or even less than 60° C. The Tg of the polyvinyl acetal resin is typically at least 35° C., at least 40° C., or at least 45° C. When the polyvinyl acetal resin has a Tg of less than 60° C., higher concentrations of high Tg monomers may be employed in comparison to those utilizing polyvinyl butyral resin. When other aldehydes, such as acetaldehyde, are used in the preparation of the polyvinyl acetal resin, the Tg may be greater than 75° C., or greater than 80° C. When the polyvinyl acetal resin has a Tg of greater than 70° C., higher concentrations of low Tg monomers may be employed in comparison to those utilizing polyvinyl acetal butyral resin.

The polyvinyl acetal (e.g., PVB) resin typically has a weight average molecular weight (Mw) of at least 10,000 g/mole, 15,000 g/mole or 30,000; and no greater than 100,000 g/mole, 80,000 g/mole or 60,000 g/mole.

The polyacetal resin is typically a random copolymer; however, block copolymers and tapered block copolymers may provide similar benefits as random copolymers. Exemplary polyvinyl acetal resins are described in U.S. Pat. Appl. Pub. No. 2021/0102100 (Xia et al.).

In certain embodiments, if used, the polyvinyl acetal resin is used in an amount of at least 5 weight percent, at least 7 weight percent, or at least 10 weight percent, based on total weight of the curable foam support layer composition. If used, the polyvinyl acetal resin is used in an amount of up to 25 weight percent, up to 20 weight percent, or up to 15 weight percent, based on total weight of the curable foam support layer composition.

In certain embodiments, the polymer modulus modifier comprises a high acid polymer. High acid in this context means there is an acrylate polymer that has higher amounts of acrylic acid in it than in a conventional pressure sensitive adhesive, which is typically a 90:10 isooctyl acrylate:acrylic acid. This makes the polymer “stiffer” (i.e., with a higher modulus).

In certain embodiments, the high acid polymer is the second (meth)acrylate copolymer comprising from 15 weight percent to 40 weight percent of (meth)acrylic acid monomer units, based on the weight of the second (meth)acrylate copolymer, described herein for the pressure sensitive adhesive of the curable adhesive free-standing film. That is, in such embodiments, the high acid polymer (i.e., the second (meth)acrylate copolymer described herein) comprise, as main monomer units, linear or branched alkyl (meth)acrylate ester monomer units selected from the group consisting of methyl (meth)acrylate, ethyl (meth)acrylate, n-propyl (meth)acrylate, isopropyl (meth)acrylate, n-butyl acrylate, isobutyl acrylate, tert-butyl (meth)acrylate, n-pentyl (meth)acrylate, iso-pentyl (meth)acrylate, n-hexyl (meth)acrylate, iso-hexyl (meth)acrylate, cyclohexyl (meth)acrylate, phenyl (meth)acrylate, octyl (meth)acrylate, iso-octyl (meth)acrylate, 2-octyl(meth)acrylate, 2-ethylhexyl (meth)acrylate, decyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, 2-propylheptyl (meth)acrylate, stearyl (meth)acrylate, isobornyl (meth)acrylate, benzyl (meth)acrylate, nonyl (meth)acrylate, isophoryl (meth)acrylate, and any combinations or mixtures thereof. In certain embodiments, the high acid polymer has a Tg of no greater than 100° C., no greater than 80° C., no greater than 60° C., no greater than 50° C., no greater than 45° C., or even no greater than 40° C. In certain embodiments, the high acid polymer has a Tg of 2° C. to 100° C., 2° C. to 80° C., 2° C. to 60° C., 2° C. to 50° C., 2° C. to 45° C., 5° C. to 45° C., 5° C. to 40° C., 5° C. to 35° C., or 10° C. to 30° C.

This high acid polymer is believed to provide outstanding mechanical properties, due in particular to the relatively high concentration of (meth)acrylic acid monomer units.

In certain embodiments, if used, the high acid polymer is used in an amount of at least 1 weight percent, at least 2 weight percent, at least 3 weight percent, or at least 4 weight percent, based on the total weight of the curable foam support layer. If used, the high acid polymer is used in an amount of up to 35 weight percent, up to 30 weight percent, up to 25 weight percent, up to 20 weight percent, or up to 15 weight percent, based on the total weight of the curable foam support layer.

### Optional Additives

Optionally, the curable foam support layer contains one or more additives. Such additives can include, for example, fillers, antioxidants, viscosity modifiers, pigments (inorganic or organic), tackifying resins, fibers, flame retardants, antistatic and slip agents, thermally conductive particles, electrically conductive particles, continuous microfibers, filaments, and mixtures thereof.

Useful fillers include, for example, glass beads, metal oxide particles, silica particles (e.g. fumed silica), ceramic microspheres, hollow polymeric microspheres (such as those available under the trade designation EXPANCEL 551 DE from Akzo Nobel, Duluth, GA), hollow glass microspheres (such as those available under the trade designation K37 from 3M Co., St Paul, MN), carbonates, metal oxides, silicates (e.g., talc, asbestos, clays, mica), sulfates (e.g., barium sulfate), metals in powder form (e.g., aluminum, zinc and iron), silicon dioxide, and aluminum trihydrate. In certain embodiments, the filler comprises solid or hollow particles. In certain embodiments, the solid or hollow particles comprise a polymer, glass, ceramic, or metal oxide material. Combinations of two or more fillers may be used if desired.

Examples of useful organic pigments include halogenated copper phthalocyanines, aniline blacks, anthraquinone blacks, benzimidazolones, azo condensations, arylamides, diarylides, disazo condensations, isoindominones, isoindolines, quinophthalones, anthrapyrimidines, flavanthrones, pyrazolone oranges, perinone oranges, beta-naphthols, BON arylamides, quinacridones, perylenes, anthraquinones, dibromanthrones, pyranthrones, diketopyrrolo-pyrrole pigments (DPP), dioxazine violets, copper and copper-free phthalocyanines, indanthrones, and the like.

Examples of useful inorganic pigments include titanium dioxide, zinc oxide, zinc sulphide, lithopone, antimony oxide, barium sulfate, carbon black, graphite, black iron oxide, black micaceous iron oxide, brown iron oxides, metal complex browns, lead chromate, cadmium yellow, yellow oxides, bismuth vanadate, lead chromate, lead molybdate, cadmium red, red iron oxide, Prussian blue, ultramarine, cobalt blue, chrome green (Brunswick green), chromium oxide, hydrated chromium oxide, organic metal complexes, laked dye pigments, and the like.

In certain embodiments, the curable foam support layer includes a filler. In certain embodiments, the filler comprises fumed silica. In certain embodiments, the filler comprises solid or hollow particles. In certain embodiments, the solid or hollow particles comprise a polymer, glass, ceramic, or metal oxide material.

Various additives may be used in amounts typical for adhesive tapes.

### Preparation of Curable Foam Support Layer

The polymer used to make the curable foam support layer may be made using conventional techniques such as solution coating onto a web. In preferred embodiments, the polymer of the curable foam support layer is hot melt processable and is made in a hot melt process. Hot meh processing, such as hot melt blending or hot melt extrusion, may be accomplished by any suitable means, including those disclosed in U.S. Pat. Pub. No. 2013/0184394 A1 (Satrijo et al.).

The polymer used to make the curable foam support layer may be initially coated onto and polymerized against a flexible backing sheet (for example, a release liner) that has a low-adhesion surface from which the polymerized layer is readily removable and almost always is self-sustaining. If the opposite face of the backing sheet also has a low adhesion surface, the backing sheet with its polymerized layer may be wound up in roll form for storage prior to assembly of the finished adhesive article.

In some embodiments, the curable foam support layer may be an open cell foam, a closed cell foam, or combination thereof. It may be a syntactic foam or a non-syntactic foam.

In certain embodiments, the curable foam support layer is a foam made using a foaming agent. In certain embodiments, the curable foam support layer comprises a foaming agent and the base polymer or oligomer. In certain embodiments, the curable foam support layer comprises a foaming agent and the same components as the curable adhesive free-standing film.

In certain embodiments, the foaming agent comprises expandable microspheres, hollow glass bubbles, nitrogen bubbles, optionally surfactant stabilized (froth formed from physical agitation and stabilized with surfactant, preferably a silicone or a fluorochemical known to be useful for foaming organic liquids that have low surface tension, such as the fluorosurfactant available from 3M Company (St. Paul, MN) under the trade designation FC-4430 and those described in U.S. Pat. No. 4,415,615 (Esmay et al.).

In some embodiments, the foam is a syntactic foam containing hollow microspheres, for example, hollow glass microspheres. Useful hollow glass microspheres include those having a density of less than 0.4 gram per milliliter (g/mL) and having a diameter of from 5 to 200 micrometers. The microspheres may be clear, coated, stained, or a combination thereof. The microspheres typically comprise from 5 to 65 volume percent of the foam composition. Examples of useful acrylic foams thus made are disclosed in U.S. Pat. No. 4,415,615 (Esmay et al.) and U.S. Pat. No. 6,103,152 (Gehlsen et al.).

In some embodiments, foams may be formed by blending expanded polymeric microspheres into a polymerizable composition. In some embodiments, foams may be formed by blending expandable polymeric microspheres into a composition and expanding the microspheres. An expandable polymeric microsphere includes a polymer shell and a core material in the form of a gas, liquid, or combination thereof. Upon heating to a temperature at or below the melt or flow temperature of the polymeric shell, the polymer shell expands to form the microsphere. Suitable core materials include propane, butane, pentane, isobutane, neopentane, isopentane, and combinations thereof. The thermoplastic resin used for the polymer microsphere shell can influence the mechanical properties of the foam, and the properties of the foam may be adjusted by the choice of microsphere, or by using mixtures of different types of microspheres. Examples of commercially available expandable microspheres include those available under the trade designation EXPANCEL from Akzo Nobel Pulp and Performance Chemicals AB, Sundsvall, Sweden. Methods of making foams containing expandable polymeric microspheres and particulars of these microspheres are described in U.S. Pat. No. 6,103,152 (Gehlisen et al.).

Foams may also be prepared by forming gas voids in a composition using a variety of mechanisms including, for example, mechanical mechanisms, chemical mechanisms, and combinations thereof. Useful mechanical foaming mechanisms include, for example, agitating (for example, shaking, stirring, or whipping the composition, and combinations thereof), injecting gas into the composition (for example, inserting a nozzle beneath the surface of the composition and blowing gas into the composition), and combinations thereof. Methods of making the foams with voids formed via a foaming agent are described in U.S. Pat. No. 6,586,483 (Kolb et al.).

In exemplary embodiments, the curable support foam layers have a foam density of from 320 kilograms per cubic meter (kg/m³) to 1041 kg/m³, from 400 kg/m³ to 880 kg/m³, or from 561 kg/m³ to 800 kg/In.

### Optional Barrier Film Support Layer

Suitable materials for barrier film support layers include, for example: metals, polyolefins, such as high-density polyethylene (HDPE), low-density polyethylene (LDPE), linear low-density polyethylene (LLDPE), ultra linear low-density polyethylene U-LLDPE) and polypropylene (PP); polyvinyl polymers, such as polyvinyl chloride (PVC) and polyvinyl acetate (PVA); polyolefin-based copolymers, such as ethylene-methacrylic acid copolymer (EEMA) and ethylene-vinyl acetate copolymer (EVA); polyurethanes; natural or synthetic rubbers; block copolymers, such as acrylic block copolymers and styrene-isoprene-vinyl acetate copolymer; polyamide-modified polyether, and thermoplastic elastomers (TPE); acrylate resins, such as polymethyl methacrylate (PMMA); polyesters, such as polyethylene terephthalate (PET); polycarbonates; norbornene-based resins; and triacetyl cellulose (TAC); and metal foils such as aluminum foil. Such materials may be used alone or in combination.

The material above may be composed of one of the aforementioned materials, or a combination of two or more thereof. For example, one or both of the barrier film support layers may be a composite film obtained by laminating and integrating two or more polymer films. Alternatively, one or both of the barrier film support layers may be a blend or copolymer of two or more of the aforementioned polymers.

Preferred materials for the barrier film support layers are thermoplastic resins that are semi-crystalline and have a melting temperature of at least 70° C., at least 75° C., at least 80° C., or at least 85° C. Preferred semi-crystalline thermoplastic resins have a melting temperature of at most 130° C., at most 125° C., at most 120° C., or at most 112° C.

Barrier film support layers may also include fillers, including tougheners, core-shell particles, solid or hollow microspheres of polymer, glass, ceramic, or metal oxide, fibers, electrically or thermally conductive materials, dyes, colorants, plasticizers, tackifiers, UV stabilizers, and the like.

### Activator

The activator, which is designed for adhering a curable adhesive free-standing film to a substrate, is a liquid at normal temperature and pressure. It includes components that initiate cure of the curable adhesive free-standing film. In some embodiments, the activator includes an oxidizing agent and a film-forming polymer or oligomer.

### Oxidizing Agent

Any suitable oxidizing agents may be used. Suitable oxidizing agents include, for example, organic peroxides, inorganic peroxides, and persulfates. Suitable organic peroxides include, for example, hydroperoxides, di-peroxides, ketone peroxides, diacyl peroxides, dialkyl peroxides, peroxyketals, peroxyesters, and peroxydicarbonates.

Suitable organic peroxides include a hydroperoxide comprising the structural moiety R—O—O—H with R being linear alkyls (e.g., C1-C20 linear alkyls), branched alkyls, (e.g., C3-C20 branched alkyls), cycloalkyls (e.g., C6-C12 cycloalkyls), alkaryls (e.g., C7-C20 alkaryls), aralkyls (e.g., C7-C20 aralkyls), and aryls (e.g., C6-C12 aryls). Exemplary organic hydroperoxides include t-butyl hydroperoxide, t-amyl hydroperoxide, p-diisopropylbenzene hydroperoxide, cumene hydroperoxide, pinane hydroperoxide, p-methane hydroperoxide, and 1,1,3,3-tetramethylbutyl hydroperoxide.

Suitable organic peroxides include di-peroxides comprising the moiety R¹—O—O—R²—O—O—R³, with R¹ and R³ being independently selected from H, linear alkyls (e.g., C1-C6 linear alkyls), branched alkyls (e.g., C1-C6 branched alkyls), cycloalkyls (e.g., C5-C10 cycloalkyls), alkaryls (e.g., C7-C12 alkaryls), aralkyls (e.g., C7-C20 aralkyls), or aryls (e.g., C6-C10 aryls), and R² being selected from linear alkyls (e.g., C1-C6 linear alkyls) or branched alkyls (e.g., C1-C6 branched alkyls).

Suitable ketone peroxides include, for example, methyl ethyl ketone peroxide, methyl isobutyl ketone peroxide, methyl cyclohexanone peroxide, and cyclohexanone peroxide. Suitable peroxyesters include, for example, alpha-cumylperoxyneodecanoate, t-butyl peroxypivarate, t-butyl peroxyneodecanoate, 2,2,4-trimethylpentylperoxy-2-ethyl hexanoate, t-amylperoxy-2-ethyl hexanoate, t-butylperoxy-2-ethyl hexanoate, di-t-butylperoxy isophthalate, di-t-butyl peroxy hexahydroterephthalate, t-butylperoxy-3,3,5-trimethylhexanoate, t-butylperoxy acetate, t-butylperoxy benzoate, and t-butylperoxymaleic acid. Suitable peroxydicarbonates include, for example, di-3-methoxy peroxidicarbonate, di-2-ethylhexyl peroxy-dicarbonate, bis(4-t-butylcyclohexyl)peroxidicarbonate, diisopropyl-1-peroxydicarbonate, di-n-propyl peroxidicarbonate, di-2-ethoxyethyl-peroxidicarbonate, and diallyl peroxidicarbonate.

Suitable diacyl peroxides include, for example, acetyl peroxide, benzoyl peroxide, decanoyl peroxide, 3,3,5-trimethylhexanoyl peroxide, 2,4-dichlorobenzoyl peroxide, and lauroylperoxide.

Suitable dialkyl peroxides include, for example, di-t-butyl peroxide, dicumylperoxide, t-butylcumyl peroxide, 2,5-dimethyl-2,5-di(t-butylperpoxy) hexane, 1,3-bis(t-butylperoxyisopropyl) benzene, and 2,5-dimethyl-2,5-di(t-butylperoxy)-3-hexane.

Suitable peroxyketals include, for example, 1,1-bis(t-butylperoxy)-3,3,5-trimethylcyclohexane. 1,1-bis(t-butylperoxy)cyclohexane, 2,2-bis(t-butylperoxy) butane, 2,2-bis(t-butylperoxy) octane, and 4,4-bis(t-butylperoxy) valeric acid-n-butylester.

Other suitable organic peroxides may additionally include t-butyl peroxy ethylhexyl carbonate, t-butyl peroxy trimethylhexanoate, t-butyl peroxy ethylhexanoate, t-amyl peroxy ethylhexanoate, t-octyl peroxy ethylhexanoate, t-amyl peroxy ethylhexyl carbonate, t-butyl peroxy isopropyl carbonate, t-butyl peroxyneodecanoate, and t-butyl peroxyisobutyrate.

In certain embodiments, the oxidizing agent is present in the activator in an amount of at least 0.5 weight percent, at least 1 weight percent, at least 2 weight percent, or at least 4 weight percent, based on the total weight of the activator composition. In certain embodiments, the oxidizing agent is present in the activator in an amount of up to 20 weight percent, up to 15 weight percent, up to 10 weight percent, or up to 5 weight percent, based on the total weight of the activator composition.

### Film-Forming Polymer or Oligomer

In addition to the oxidizing agent, in some embodiments, the activator includes a film-forming polymer or oligomer.

In some embodiments, the film-forming polymer or oligomer is one described herein for the curable adhesive free-standing film. In some embodiments, the film-forming polymer or oligomer is a reactive polymer or oligomer comprising unsaturated free-radically polymerizable groups, as described herein for the curable adhesive free-standing film. In some embodiments, the film-forming polymer or oligomer is distinct from a reactive species comprising unsaturated free-radically polymerizable groups, as described herein for the curable adhesive free-standing film. Thus, in some embodiments, the activator may include a reactive species comprising unsaturated free-radically polymerizable groups, as described herein for the curable adhesive free-standing film. These components may be the same or different from these components in the curable adhesive free-standing film.

In some embodiments, the film-forming polymer may include a rubber and/or a (meth)acrylic resin. In some embodiments, the (meth)acrylic resin is a (meth)acrylic polymer made from any of the monomers described above for the curable adhesive free-standing film and the curable foam support layer. In some embodiments, the (meth)acrylic polymer is any of those described above for the curable adhesive free-standing film and the curable foam support layer.

In some embodiments, the rubber comprises a block copolymer of a styrene and an alkene. In some embodiments, the rubber comprises a styrene-ethylene/butylene-styrene block copolymer grafted with maleic anhydride. In some embodiments, the rubber comprises at least one of a styrene-isoprene-styrene copolymer, styrene-butadiene-styrene copolymer, a styrene-ethylene-butylene-styrene copolymer.

In some embodiments, the (meth)acrylic resin is an amine-functional (meth)acrylic resin is a polymerization reaction product of an amine-functional (meth)acryloyl compound (e.g., amine-functional (meth)acrylic acid esters and amides) and a non-amine-vinyl monomer, as described in U.S. Pat. No. 10,640,656 (Moren et al.). In some embodiments, the amine-functional (meth)acrylic resin has a calculated glass transition temperature (Tg) greater than or equal to 12° C. In some embodiments, the amine-functional (meth)acrylic resin has a calculated Tg greater than or equal to 20° C. In some embodiments, the amine-functional (meth)acryloyl compound (e.g., amine-functional (meth)acrylic acid esters and amides) include 2-(N,N-dimethylaminoethyl)(meth)acrylate, 2-(N,N-diethylaminoethyl) (meth)acrylate, 2-(t-butylaminoethyl)(meth)acrylate, 2-(N, N-dimethylaminoethyl)(meth)acrylamide, 2-(N,N-diethylaminoethyl)(meth)acrylamide, 2-(t-butylaminoethyl)(meth)acrylamide, and N-(meth)acryloylpiperidine. In some embodiments, the non-amine-vinyl monomer is selected from the group consisting of a (meth)acrylic acid, a (meth)acrylic acid ester, a (meth)acrylamide, a vinyl ester, a styrene, a (meth)acrylonitrile, and mixtures thereof. In some embodiments, the non-amine-vinyl monomer is a (meth)acrylic acid ester of a C1 to C18 alcohol.

### Optional Additives

In some embodiments, the activators also include components as described herein for the curable adhesive free-standing film. For example, in some embodiments, the activators also include a transition metal cation, as described herein for the curable adhesive free-standing film.

In some embodiments, the activator includes a plasticizer. In some embodiments, the plasticizer is of the following formula: (R—X—)ₙZ, wherein: each R may be hydrogen, C1-C14 alkyl, aryl, alkaryl, or aralkyl, each optionally interrupted by oxygen, nitrogen, carbonyl, carboxyl, or carbamide, each X may be oxygen, nitrogen, carbonyl, carboxyl, or carbamide; Z may be a hydrogen, C1-C14 alkyl, aryl, alkaryl, aralkyl, C1-C14 alkylene, arylene, alkarylene, aralkylene, each optionally interrupted by oxygen, nitrogen, carbonyl, carboxyl, or carbamide; and n is an integer of 1 to 5. In some embodiments, n is an integer of 1 to 4.

In some embodiments, the plasticizer is selected from at least one of the following: a benzoic acid ester, a myristic acid ester, a citric acid ester, an acetic acid ester, a succinic acid ester, a glutaric acid ester, an adipic acid ester, a sebacic acid ester, and combinations thereof. In some embodiments, the plasticizer is selected from at least one of the following: a benzoic acid ester, a myristic acid ester, a citric acid ester, and combinations thereof. A citric acid ester may have one, two, three, or four R groups.

The activator composition further comprises a liquid carrier. In some embodiments, the liquid carrier is a solvent. In some embodiments, the activator composition comprises 75 weight percent to 99 weight percent, or 93 weight percent to 98 weight percent, of the solvent, wherein the weight percentages are all based on the total weight of the activator composition.

In some embodiments, the activator composition further includes a silane (e.g., epoxy silane).

In some embodiments, the activator includes no tackifier, no species comprising unsaturated free-radically polymerizable groups, or both.

### Method of Making a Bonded Article

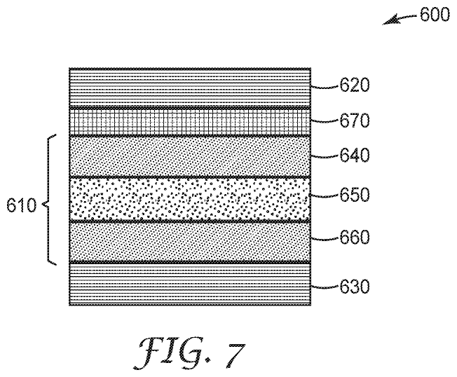

As shown in FIG. 7, a double-sided tape 610, according to one embodiment of the present disclosure, that includes curable adhesive free-standing films 640 and 660 adjacent to a single curable foam support layer 650 is applied to first substrate 630 such that curable adhesive free-standing film 660 is in contact with first substrate 630. An activator in the adhesive system of the present disclosure is applied to second substrate 620 and typically allowed to dry to form and activator layer 670 adjacent to the second substrate 620. After applying the tape and the activator to their respective substrates and waiting for any desirable independently selected length of time, the activator layer 670 and the curable adhesive free-standing film 640 of the double-sided tape 610 are brought into contact. Once the activator layer 670 and the curable adhesive free-standing film 640 are brought into contact, curing begins and continues through foam support layer 650 and curable adhesive free-standing film 660. The tape cures to form cured structural adhesive layers from curable adhesive free-standing films 640 and 660 and cured foam support layer 650. In some embodiments, the assembly is held by external forces, e.g., a clamp, until the curable adhesive films become cured: however, in other embodiments, the tackiness of the tape alone holds the assembly until cure. Activator layer 670 may be cured or simply dried m the final cured construction 600, which include two substrates bonded together by a double-sided tape including structural adhesive bonds.

In some embodiments of the adhesive system of the present disclosure, the tape may be attached to a substrate at the point of manufacture and bonded at a different time and/or place. In some embodiments, the tape may be attached to a first substrate at the point of manufacture, and the tape may optionally be covered with a conventional release liner for any period of time before bonding it to an activated second substrate. The activator may be applied to a second substrate and allowed to dry at a second point of manufacture, and the first substrate having the tape thereon and the activated second substrate may be bonded at the second point of manufacture or even at a third time and/or place.

Advantageously, as shown in the Examples below, the tape in the adhesive system of the present disclosure can be applied to a first aluminum substrate and optionally covered with a release liner to prevent any contamination of the curable adhesive free-standing film surface. Once the release liner is removed and the curable adhesive free-standing film is brought into contact with a second aluminum substrate having an activator layer, the tape cures, and a structural adhesive is formed as evidenced by the overlap shear data in Table 4. Also as shown in Table 4, the overlap shear strength provided by the adhesive system of the present disclosure remains stable for a period of three days up to six weeks after the tape is applied the first aluminum substrate. Thus, it is possible to apply the tape to a substrate at a first time or location and bond it to an activated second substrate at a later time or different location, providing flexibility in making bonded articles using the adhesive system of the present disclosure.

Therefore, the present disclosure provides a method of making a bonded article. The method includes applying a tape as described above in any of its embodiments to a first substrate, applying an activator as described above in any of its embodiments to a second substrate, and contacting the tape on the first substrate and the activator on the second substrate to bond the first and second substrates. In some embodiments, applying the tape is carried out at least 1, 3, or 5 days or at least 1, 2, 3, 4, 5, or 6 weeks before contacting the tape on the first substrate and the activator on the second substrate. In some embodiments, the tape is covered with a release liner, in some embodiments, for any of the times described above, and the release liner is removed before contacting the tape on the first substrate and the activator on the second substrate. In some embodiments, the activator is allowed to dry before contacting the tape on the first substrate and the activator on the second substrate.

In another embodiment of the method of making a bonded article, the tape 510 including barrier layer 590 as shown in FIG. 5 may be useful. An activator may be used when bonding tape 510 to a first substrate, for example, through third curable adhesive free-standing film 540″. The layers 540′/550′/560′ cure to form cured structural adhesive layers while barrier 590 may prevent curing of layers 540/550/560. Another, independently selected, activator may be used to bond tape 510 to a second substrate through first curable adhesive free-standing film 540. The layers 540/550/560 may then cure to form structure adhesive layers. In this embodiment as well, it is possible to apply the tape to a substrate at a first time or location and bond it to an activated second substrate at a later time or different location, providing flexibility in making bonded articles using the adhesive system of the present disclosure.

### Select Embodiments of the Present Disclosure

Embodiment 1 is an adhesive system comprising:
a tape comprising: a curable adhesive free-standing film adjacent to a curable foam support layer, wherein the curable adhesive free-standing film comprises: a) a film-forming polymer or oligomer; b) a species comprising unsaturated free-radically polymerizable groups, which may be a) or a species other than a); and c) a transition metal cation (in certain embodiments, the curable free-standing films also include a redox accelerator); and
an activator for adhesion of a curable adhesive free-standing film to a substrate, the activator comprising: d) an oxidizing agent: wherein the activator is a liquid at normal temperature and pressure.

Embodiment 2 is the adhesive system of embodiment 1, wherein the foam is a closed cell, open cell, syntactic, or non-syntactic foam.

Embodiment 3 is the adhesive system of embodiment 1 or 2, wherein the curable foam support layer comprises a base polymer or oligomer which may be the same or different than the film-forming polymer or oligomer of the curable adhesive free-standing film. Embodiment 4 is the adhesive system of embodiment 3, wherein the curable foam support layer comprises a base polymer or oligomer which is the same as the film-forming polymer or oligomer of the curable adhesive free-standing film. Embodiment 5 is the adhesive system of embodiment 3 or 4, wherein the base polymer or oligomer comprises an acrylate or a silicone. Embodiment 6 is the adhesive system of embodiment 5, wherein the base polymer or oligomer comprises a poly(methacrylate polymer or oligomer.

Embodiment 7 is the adhesive system of any of the preceding embodiments, wherein the curable foam support layer comprises a crosslinker within the curable foam support layer or wherein the curable foam support layer comprises a crosslinker that is migratable into the curable foam support layer (from the curable adhesive free-standing film). Embodiment 8 is the adhesive system of embodiment 7, wherein the crosslinker is the same or different than the species comprising unsaturated free-radically polymerizable groups of the curable adhesive free-standing film. Embodiment 9 is the adhesive system of embodiment 8, wherein the crosslinker is the same as the species comprising unsaturated free-radically polymerizable groups of the curable adhesive free-standing film. Embodiment 10 is the adhesive system of embodiment 9, wherein the curable foam support layer comprises a foaming agent and the same components as the curable adhesive free-standing film. Embodiment 11 is the adhesive system of embodiment 8, wherein the crosslinker is the species comprising unsaturated free-radically polymerizable groups of the curable adhesive free-standing film that migrates and/or has migrated (i.e., having migrated) into the curable support laver.

Embodiment 12 is the adhesive system of any one of embodiments 3 to 11, wherein the curable foam support layer comprises a foaming agent and the base polymer or oligomer. Embodiment 13 is the adhesive system of embodiment 10 or 12, wherein the foaming agent comprises expandable microspheres, hollow glass bubbles, nitrogen bubbles, optionally surfactant stabilized (froth formed from physical agitation and stabilized with surfactant (e.g., a fluorinated surfactant)), or a combination thereof.

Embodiment 14 is the adhesive system of any of the preceding embodiments, wherein the curable foam support layer further comprises a polymer modulus modifier. Embodiment 15 is the adhesive system of embodiment 14, wherein the polymer modulus modifier comprises a polymer having a Tg of no greater than 100° C., no greater than 90° C., no greater than 80° C. no greater than 70° C., no greater than 60° C., no greater than 50° C., or no greater than 40° C. Embodiment 16 is the adhesive system of embodiment 15, wherein the polymer modulus modifier comprises a polyvinyl acetal resin (e.g., polyvinyl butyral). Embodiment 17 is the adhesive system of embodiment 15, wherein the polymer modulus modifier comprises a high acid polymer.

Embodiment 18 is the adhesive system of any of the preceding embodiments, wherein the curable foam support layer further comprises optional additives selected from the group of fillers, antioxidants, viscosity modifiers, pigments, tackifying resins, fibers, flame retardants, antistatic and slip agents, thermally conductive particles, electrically conductive particles, continuous microfibers, filaments, and mixtures thereof. In certain embodiments, the curable foam support layer also includes a transition metal cation and a redox accelerator, as described herein for the curable adhesive free-standing film.

Embodiment 19 is the adhesive system of any of the preceding embodiments, wherein the curable foam support layer comprises a filler. Embodiment 20 is the adhesive system of embodiment 19, wherein the filler comprises fumed silica. Embodiment 21 is the adhesive system of embodiment 19, wherein the filler comprises solid or hollow particles. Embodiment 22 is the adhesive system of embodiment 21, wherein the solid or hollow particles comprise a polymer, glass, ceramic, or metal oxide material.

Embodiment 23 is the adhesive system of any of the preceding embodiments, wherein the curable foam support layer is hot melt processable. Embodiment 24 is the adhesive system of any of the preceding embodiments, wherein the curable adhesive free-standing film is a hot melt processable adhesive.

Embodiment 25 is the adhesive system of any of embodiments 1 through 24, wherein the curable adhesive free-standing film is borne on a first major surface of the curable foam support layer.

Embodiment 26 is the adhesive system of any of embodiments 1 through 24, wherein the curable adhesive free-standing film is directly bound to (e.g., laminated to) a first major surface of the curable foam support layer.

Embodiment 27 is the adhesive system of any of claims 1 through 26, further comprising a barrier film support layer adjacent a surface of the curable foam support layer opposite the curable adhesive free-standing film.

Embodiment 28 is the adhesive system of any of claims 1 through 26, further comprising a secondary adhesive layer adjacent to a surface of the curable foam support layer opposite the curable adhesive free-standing film.

Embodiment 29 is the adhesive system of any of embodiments 1 through 24, wherein:
the curable adhesive free-standing film is a first curable adhesive free-standing film;
the tape additionally comprises a second curable adhesive free-standing film, wherein the second curable adhesive free-standing film comprises components comprising: a) a film-forming polymer or oligomer: b) a species comprising unsaturated free-radically polymerizable groups, which may be a′) or a species other than a); and c′) a transition metal cation; and
the second curable adhesive free-standing film is adjacent to a surface of the curable foam support layer opposite the first curable adhesive free-standing film.

Embodiment 30 is the adhesive system of embodiment 29, wherein the first curable adhesive free-standing film is borne on a first major surface of the curable foam support layer and the second curable adhesive free-standing film is borne on a second major surface of the curable foam support layer. Embodiment 31 is the adhesive system of embodiment 29, wherein the first curable adhesive free-standing film is directly bound to a first major surface of the curable foam support layer and the second curable adhesive free-standing film is directly bound to a second major surface of the curable foam support layer.

Embodiment 32 is the adhesive system of any of embodiments 1 through 24, wherein:
the curable adhesive free-standing film is a first curable adhesive free-standing film;
the tape additionally comprises a barrier film support layer and a second curable adhesive free-standing film, wherein the second curable adhesive free-standing film comprises components comprising: a′) a film-forming polymer or oligomer; b′) a species comprising unsaturated free-radically polymerizable groups, which may be a′) or a species other than a); and c′) a transition metal cation;
the barrier film support layer is adjacent to a surface of the curable foam support layer opposite the first curable adhesive free-standing film; and
the second curable adhesive free-standing film is adjacent to a surface of the barrier film support layer opposite the curable foam support layer.

Embodiment 33 is the adhesive system of any of embodiments 1 through 24, wherein:
the curable adhesive free-standing film is a first curable adhesive free-standing film;
the curable foam support layer is a first curable foam support layer;
the tape additionally comprises a barrier film support layer, a second adhesive free-standing film, and a second curable foam support layer, wherein the second curable adhesive free-standing film comprises components comprising: a′) a film-forming polymer or oligomer; b′) a species comprising unsaturated free-radically polymerizable groups, which may be a′) or a species other than a′); and c′) a transition metal cation;
the barrier film support layer is adjacent to a surface of the first curable foam support layer opposite the first curable adhesive free-standing film;
the second curable foam support layer is adjacent to a surface of the barrier film support layer opposite the first curable foam support layer, and
the second curable adhesive free-standing film is adjacent a surface of the second curable foam support layer opposite the barrier film support layer.

Embodiment 34 is the adhesive system of any of embodiments 1 through 24, wherein:
the curable adhesive free-standing film is a first curable adhesive free-standing film;
the curable foam support layer is a first curable foam support layer;
the tape additionally comprises a barrier film support layer, a second, third, and fourth adhesive free-standing film, and a second curable foam support layer;
the layers are arranged in the following order: first curable adhesive free-standing film, first curable foam support layer, second curable adhesive free-standing film, barrier film support layer, third curable adhesive free-standing film, second curable foam support layer, and third curable adhesive free-standing film; and
the curable adhesive free-standing films include components that are the same or different (i.e., they are independently selected), and the curable foam support layers include components that are the same or different (i.e., are independently selected).

Embodiment 35 is the adhesive system of any of the previous embodiments that include a barrier film support laver, wherein the barrier film support layer includes, for example: metals, polyolefins, such as high-density polyethylene (HDPE), low-density polyethylene (LDPE), linear low-density polyethylene (LLDPE), ultra linear low-density polyethylene U-LLDPE) and polypropylene (PP); polyvinyl polymers, such as polyvinyl chloride (PVC) and polyvinyl acetate (PVA); polyolefin-based copolymers, such as ethylene-methacrylic acid copolymer (EEMA) and ethylene-vinyl acetate copolymer (EVA); polyurethanes; natural or synthetic rubbers; block copolymers, such as acrylic block copolymers and styrene-isoprene-vinyl acetate copolymer; polyamide-modified polyether, and thermoplastic elastomers (TPE); acrylate resins, such as polymethyl methacrylate (PMMA); polyesters, such as polyethylene terephthalate (PET), polycarbonates; norbornene-based resins; and triacetyl cellulose (TAC).

Embodiment 36 is the adhesive system of any of the preceding embodiments, wherein the tape has a compliance of at least 0.5 mil (12.7 micrometers) per the Lang Test described in the Examples Section.

Embodiment 37 is the adhesive system of any of embodiments 1 through 36, wherein b) is a) in the curable adhesive free-standing film. Embodiment 38 is the adhesive system of any of embodiments 1 through 36 wherein b) is a species other than a), wherein a) does not comprise unsaturated free-radically polymerizable groups.

Embodiment 38 is the adhesive system of any of the preceding embodiments, wherein the activator comprises a film-forming polymer or oligomer.

Embodiment 39 is the adhesive system of any of the preceding embodiments, wherein the activator comprises no tackifier, no species comprising unsaturated free-radically polymerizable groups, or both.

Embodiment 40 is the adhesive system of any of the preceding embodiments, wherein the curable adhesive free-standing film comprises an outer surface bearing embossed air bleed channels capable of aiding in escape of air during application of the outer surface to a substrate.

Embodiment 41 is a method of making a bonded article, the method comprising applying a tape as described in any of embodiments 1 to 37 or 40 to a first substrate, applying an activator as described in any of embodiments 1, 38, and 39 to a second substrate, and contacting the tape on the first substrate and the activator on the second substrate to bond the first and second substrates.

Embodiment 42 is the method of embodiment 41, wherein applying the tape is carried out at least 1, 3, or 5 days or at least 1, 2, 3, 4, 5, or 6 weeks before contacting the tape on the first substrate and the activator on the second substrate.

Embodiment 43 is the method of embodiment 41 or 42, wherein the tape is covered with a release liner, the method further comprising removing the release liner before contacting the tape on the first substrate and the activator on the second substrate.

Embodiment 44 is the method of embodiment 41 or 42, further comprising applying an activator as described in any of embodiments 1, 38, or 39 to the first substrate, wherein the tape is as described in any one of embodiments 32 to 35.

### EXAMPLES

Objects and advantages of this disclosure are further illustrated by the following non-limiting examples, but the particular materials and amounts thereof recited in these examples, as well as other conditions and details, should not be construed to unduly limit this disclosure.

Unless otherwise noted, all parts, percentages, ratios, etc. in the Examples and the rest of the specification are by weight.

| | |
|---|---|
| M1 | A compound prepared as described in Example 1 of U.S. Pat. No. |
| | 9,102,774 (Clapper et al.) |
| AA | Acrylic acid available from Sigma Aldrich, St. Louis, MO, USA |
| Photoinitiator-1 | 2,2-dimethoxy-1,2-diphenylethan-1-one, obtained under the trade |
| | designation IRGACURE 651 from BASF Corporation, Florham Park, |
| | NJ, USA |
| CuOAc | Copper (II) acetate monohydrate from Alfa Acsar, Ward Hill, MA, |
| | USA |
| Antioxidant-1 | Octadecyl-[3-(3,5-di-tert-butyl-4-hydroxyphenyl)propionate], obtained |
| | under the trade designation IRGANOX 1076 from BASF Corporation, |
| | Florham Park, NJ, USA |
| HDDA | 1,6-Hexanediol diacrylate available from Sigma Aldrich, St. Louis, |
| | MO, USA |
| DTMPTA | Ditrimethylolpropane tetraacrylate (DTMPTA) available under the trade designation MIRAMER M410 from Miwon Specialty Chemical Co., Ltd., Exton, PA, USA 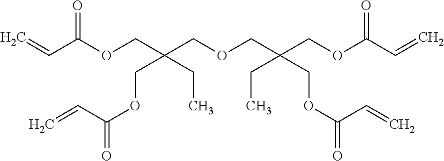 [SMILES: C=CC(=O)OCC(CC)(COCC(CC)(COC(=O)C=C)COC(=O)C=C)COC(=O)C=C] |
| BTEAC | Benzyltriethylammonium chloride available from Lindau |
| | Chemicals, Inc., Columbia, SC, USA |
| EHA | 2-ethylhexyl acrylate obtained under the trade designation 2-EHA from |
| | BASF Corporation, Florham Park, NJ, USA |
| IBOA | isobornyl acrylate obtained under the trade designation IBXA from |
| | Kowa American Corporation, New York, NY, USA |
| HEA | 2-hydroxyethyl acrylate available from Sigma Aldrich, St. Louis, MO, |
| | USA |
| Photoinitiator-2 | bis(2,4,6-trimethylbenzoyl)-phenylphosphineoxide obtained under the |
| | trade designation IRGACURE 819 from BASF Corporation, Florham |
| | Park, NJ, USA |
| PVB | Low viscosity Poly(vinyl butyral) obtained under the trade designation |
| | MOWITOL B60H from Kuraray America, Inc., Houston, TX, USA |
| STABILIZER | A fluorinated surfactant obtained under the trade designation 3M |
| | NOVEC FLUOROSURFACTANT FC 4430 |
| DENSITY MODIFIER | An expandable microsphere obtained under the trade designation |
| | DUALITE U010-185D from Chase Corporation, Westwood, MA, |
| | USA |
| PE | A 0.033 inch thick polyethylene foam obtained under the trade |
| | designation VOLARA 6EO from Sekisui-Voltek, Coldwater, MI, USA |
| MEK | Methyl ethyl ketone, obtained from Avantor Performance Materials, |
| | Center Valley, PA, USA |
| IPA | Isopropyl alcohol, obtained from Sigma Aldrich, St. Louis, MO, USA |
| Acetone | Acetone, obtained from Sigma Aldrich, St. Louis, MO, USA |
| TBEC | Tert-Butylperoxy 2-ethylhexyl carbonate, obtained under the trade |
| | designation LUPEROX TBEC from Arkema Inc., King of Prussia, PA, |
| | USA |
| UPUV | A primer for pressure sensitive adhesives, obtained under the trade |
| | designation 3M VHB UNIVERSAL PRIMER UV from 3M Company, |
| | St. Paul, MN, USA |
| IOTG | Isooctyl thioglycolate, a chain transfer agent obtained from Bruno |
| | Bock Chemische Fabrik GmbH & Co. KG, Marschacht, Germany |
| DCPA | Dihydrodicyclopentadienyl acrylate obtained under the trade |
| | designation DIHYDRODICYCLOPENTADIENYL ACRYLATE |
| | (DCPA) BASF SE, Ludwigshafen, Germany |
| AMVN | 2,2′-Azobis(2,4 dimethylpentanenitrile), a free radical initiator |
| | obtained under the trade designation VAZO 52 available from The |
| | Chemours Company, Wilmington, DE, USA |
| PI 3 | 2,2-dimethoxy-2-phenylacetophenone, a UV-initiator obtained under |
| | the trade designation OMNIRAD BDK from iGm resins, Waalwijk, |
| | Netherlands |
| GB | Hollow glass spheres with a typical density of 0.15 g/cc and isostatic |
| | crush strength of 300 psi obtained under the trade designation 3M |
| | GLASS BUBBLES K15 from 3M Company, St. Paul, MN, USA |
| FS | Hydrophobic fumed silica particles obtained under the trade |
| | designation AEROSIL R 972 from Evonik, Hanau-Wolfgang, |
| | Germany |
| PET | 0.5 mil (12 micron) thick polyester film treated as described in EP- |
| | 372756B1 (published December 29, 1993) |
| BP | Black color concentrate mixture consisting of a 50/50 blend of carbon |
| | black in ethylene vinyl acetate copolymer resin obtained under the |
| | trade designation 4105 VAC BLACK from Avient, Avon Lake, OH, |
| | USA |
| IOA | Isooctyl acrylate obtained from 3M Company, St. Paul, MN, USA |
| NVC | N-vinylcaprolactam obtained under the trade designation NVC from |
| | BASF, Florham Park, NJ, USA |
| AIBN | 2,2′-Azobis(2-methylpropionitrile) obtained under the trade |
| | designation VAZO-64 from E. I. du Pont de Nemours & Company, |
| | Wilmington, DE, USA |
| Polymer 2 | A clear, linear triblock copolymer based on styrene and |
| | ethylene/butylene obtained under the trade designation KRATON |
| | FG1901 from Kraton Polymers US LLC, Houston, TX, USA |
| OB | 2,5-thiophenediylbis(5-tert-butyl-1,3-benzoxazole) obtained under the |
| | trade designation TINOPAL OB from BASF, Florham Park, NJ, USA |
| ATBC | Tributyl acetylcitrate obtained under the trade designation PUROLAN |
| | ATBC from Lanxess, Pittsburgh, PA, USA |
| SI | 2-(3,4-epoxycyclohexyl)ethyltrimethoxysilane obtained under the trade |
| | designation SILQUEST A186 SILANE from Momentive, Columbus, |
| | OH, USA |

### EXAMPLES

### Preparation of Acrylate Ester Polymer

A terpolymer consisting of iso-octyl acrylate/N-vinylcaprolactam/acrylic acid (IOA/NVC/AA) in a weight ratio of 78:20:2 was prepared as follows. To a 237-mL narrow-mouthed bottle were added 39 grams (g) of IOA, 10 g of NVC, 1 g of AA, 0.1 g AIBN and 75 g of ethyl acetate. The resulting solution was purged with dry argon for three minutes and sealed. The sealed bottle was then tumbled in a rotating water bath at 55° C. for 24 hours. The percentage of conversion was determined to be 99.1% by infrared spectrophotometric analysis. The solution had a viscosity of about 7500 cps. The inherent viscosity was determined to be about 0.72 deciliters/gram (dl/g) using the test method described below.

### Preparation of Adhesive Film 1

Adhesive Film 1 was made by combining a polymer, and a liquid blend. The polymer was prepared as described in Synthesis Example SI of U.S. Pat. Pub. No. 2013/0184394 A1 (Satrijo et al.) except that the pre-adhesive composition was as follows: 89.480 weight percent M1, 9.942 weight percent AA. 0.149 weight percent Photoinitiator-1, 0.030 weight percent CuOAc, 0.398 weight percent Antioxidant-1, and 0.001 weight percent HDDA. The liquid blend was prepared by using a diaphragm pump (Wilden Pump and Engineering, Grand Terrace, CA, USA) to add 132.8 pounds (lb) (60.2 kilograms (kg)) of DTMPTA to a HM-2.5 basketmill (Hockmeyer Equipment Corporation, Elizabeth City, NC, USA) with 9-spindle hub having been preloaded with clean Zirmil 1.5-millimeter (mm) bead media and equipped with a 0.5-mm Tungsten coated screen and HM-2.5 turbo prop. When addition of DTMPTA was complete, 17.2 lb (7.8 kg) of BTEAC was added to the basketmill using a paddle mixer to incorporate. The mixture was milled for 3 hours at 800 revolutions per minute (rpm) with cooling jacket set at 70° F. (21° C.). Milled material was further diluted by addition of 254.1 lbs (115.3 kg) of DTMPTA for every 45.9 lbs (20.8 kg) of milled material. This diluted material, a liquid blend, was combined at 28.5 weight percent with the polymer described above as described in Hotmelt Compounding of PSA Adhesive Tape in International Publication No. WO2021/176376 (Kugel et al.) at 71.5 weight percent to create Adhesive Film 1.

Preparation of Curable Foam Support layer 1 with High Acid Polymer

Curable Foam Support layer 1 with high acid polymer (HAP) was made by making a liquid mixture containing a high acid polymer and coating into a film. The high acid polymer (having composition shown in Table 1) was prepared as described below.

TABLE 1
High Acid Polymer (HAP) Composition

| Component | EHA | AA | IOTG | AMVN |
|---|---|---|---|---|
| Weight Percent | 79.9678 | 19.9919 | 0.0400 | 0.0003 |

The polymerization of monomers described in Table 1 was carried out using a Büchi Polycave stainless steel reactor (Buchi Labortechnik GmbH, The Netherlands). The Büchi reactor was charged with 250 grams of a mixture consisting of the monomer mixture and amounts shown in Table 1. The reactor was sealed and purged of oxygen and then held at approximately 1 bar nitrogen pressure. The reaction mixture was heated to 60° C. and the reaction proceeded adiabatically. The reaction peak temperature was 110° C. When the reaction was complete the mixture was cooled to below 50° C. The polymerization conversion was approximately around 35%. The high acid polymer was then combined in a polymerization precursor comprising EHA and AA. During dilution, the resulting composition was mixed, and the mixing was stopped when a viscosity of between 2000 and 4500 mPas was reached (as measured with a Brookfield viscometer (AMETEK GmbH/B.U. Brookfield, Hadamar-Steinbach, Germany) at a temperature of 25° C. using spindle 4 at 12 rpm). When the desired viscosity was reached, PI 3, HDDA, DCPA, and FS were added and again mixed. Finally, GB was added and the mixture was stirred with a propeller stirrer (300 rpm) for 5 minutes until they were evenly dispersed. The exact composition (in weight percent) of the liquid mixture is listed in Table 2 below.

TABLE 2
Liquid Mixture Composition

| | EHA | AA | HAP | HDDA | DCPA | PI 3 | FS | GB |
|---|---|---|---|---|---|---|---|---|
| Weight | 71.8954 | 9.8039 | 9.8039 | 0.1634 | 4.085 | 0.1634 | 1.634 | 2.451 |
| Percent | | | | | | | | |

Curable Foam Support layer 1 with high acid polymer was obtained by coating the liquid mixture on 75-micron (3-mil) siliconized PET-liners (SLVK-Liner having a dimension of 300 mm×300 mm) using a dual-liner lab-coater. The line speed of the coater was set to 1 meter per minute (m/min). The resulting thickness was 140 microns (5.5 mil). Curing was accomplished from both the top and bottom sides in a UV-curing station with a length of 300 centimeters (cm) at the line speed given above. The total radiation intensity irradiated cumulatively from top and bottom was approximately 3 milliwatts per square centimeter (mW/cm²).

Preparation of Curable Foam Support Layer 2 with PVB

Curable Foam Support Layer 2 with PVB was made by making a liquid mixture followed by coating into a film. First, a liquid mixture was prepared as described in the adhesive composition of Example 2 of U.S. Pat. Appl. Pub. No. 2021/0102100 (Xia et al.) except that the composition was as follows: 50.3863 weight percent EHA. 8.3977 weight percent IBOA, 14.2509 weight percent AA. 14.2509 weight percent HEA, 1.1001 weight percent Photoiniator-2, 11.5637 weight percent PVB, and 0.0504 weight percent HDDA. Second, the mixture was coated and cured as described in Example 13 of International Publication No. WO 2017/112453 (Janoski et al.) except that the UV delivered was 4 mW/cm² on the top and bottom for 200 seconds, the total gap setting was adjusted to deliver a final caliper of 0.005 inches (127 micrometers) and the composition was aerated with nitrogen prior to coating using an Oakes Foamer (E.T. Oakes Corporation, Hauppauge, NY) with STABILIZER.

### Preparation of Curable Foam Support Layer 3

Curable Foam Support layer 3 was prepared as described in Adhesive Film 1 except that the composition was as follows: 67.7 weight percent polymer used in preparation of Adhesive Film 1, 28.8 weight percent liquid blend used in preparation of Adhesive Film 1, and 3.5 weight percent DENSITY MODIFIER. The thickness was 10 mil (0.26 mm).

### Preparation of Double-Sided Tape

Multilayer constructions were assembled by laying the curable foam support layer materials face-up on a horizontal surface. Adhesive Film 1 was applied by rolling the release liner-backed Adhesive Film 1 down onto the exposed flat surface of the support layer with a 2-inch (5.1-cm) firm rubber roller (MARSHALLTOWN, Marshalltown, IA). After the initial contact was made the rubber roller was used to roll the entire surface so that air bubbles between the curable foam support layer and Adhesive Film 1 were minimized and full contact was insured. This process was repeated for the opposing side of the support layer so that the support layer was faced on both sides with Adhesive Film 1. This process was carried out for each of the Curable Foam Support Layers 1, 2, and 3 as well as PE.

### Preparation of Example 5 Multilayer Tape

A three-layer co-extruded tape was prepared by co-extruding a first and second curable adhesive free-standing film layer onto the opposing sides of the curable support layer. The composition of the curable foam support layer was 68.74 weight percent polymer used in preparation of Adhesive Film 1, 28.5 weight percent liquid blend used in preparation of Adhesive Film 1, 2.00 weight percent DENSITY MODIFIER, 0.76 weight percent BP. The composition of the first and second curable adhesive free-standing films was 70.71 weight percent polymer used in preparation of Adhesive Film 1, 28.5 weight percent liquid blend used in preparation of Adhesive Film 1, and 0.79 weight percent BP. The total thickness of the tape from the three-layer multi manifold film die was 12 mil (0.30 mm). The three-laver co-extruded tape was cast between a silicone coated casting roll and a silicone coated paper liner entrained by a second chill roll. The chill rolls were cooled with water at a temperature of about 13° C. Once cooled down, the co-extruded tape left the silicone release coated roll thereby adhering to the silicone coated paper liner and was then rolled up in a winding station.

### Preparation of Activator

Activator was prepared as described in Example 1 of International Publication No. WO 2021/176376 (Kugel et al.) except that the composition was as follows: 4.0 weight percent TBEC and 96.0 weight percent UPUV.

### Preparation of Activator Used in Example 5

A 5-liter flask equipped with overhead stirring, thermocouple, condenser, and nitrogen inlet was charged with 100.0 grams Polymer 2, 0.15 grams OB, 48.0 grams ATBC, 120.0 grams Acrylic Ester Polymer and 4.0 grams SI. Stirring was started, 2090 grams of heptane was added, and the mixture was heated 3 hours at 60° C. to ensure homogeneous solution. The solution was cooled to ambient temperature, then sequentially diluted with 1710 grams of methyl acetate, and 301.1 grams of TBEC. The final solution was found to have 11.65 weight percent solids.

### Test Methods

### Inherent Viscosity

The inherent viscosity was measured by conventional means using a Cannon-Fenske #50 viscometer in a water bath controlled at 25° C. to measure the flow time of 10 mL of polymer solution (0.15 g of polymer per deciliter of ethyl acetate).

### Dynamic Shear Adhesion Test

A dynamic overlap shear test was performed at 71° F. (22° C.) using an Insight 30EL load frame (MTS, Eden Prairie, MN). Test specimens were loaded into the grips and the crosshead was operated at 10 inches (25.4 cm) per minute, loading the specimen to failure. Stress at break was recorded in units of pounds per square inch (psi) using testing methods disclosed in ASTM D1002. Six test specimens were prepared, and the average was taken and reported. The adhesion failure mode was recorded as cohesive, adhesive or 2-bond. Cohesive failure is defined as failure within the Curable Foam Support Layer, splitting the foam. Adhesive failure is defined as failure between the Adhesive Film 1 and the substrate. 2-bond failure is defined as interlaminar failure between Adhesive Film 1 and Curable Foam Support Layer.

### Lang Compliance Test

Acrylic substrates 3-inch by 11-inch by 0.25-inch (7.6-cm by 27.9-cm by 6.5-mm) were washed with IPA. A Fineness of Grind Gauge No. 65 (Paul N. Gardner Company, Pompano Beach, FL) was cleaned with MEK. Specimens were made by cutting a 1-inch by 6-inch (2.5-cm by 15.2-cm) strip of double-sided adhesive tape. The strip was then applied to the acrylic substrate so that the edge of the strip was 0.5-inch (1.3-cm) from side and 0.5-inch (1.3-cm) from end of acrylic substrate. A rubber roller previously described was used to eliminate air bubbles and insure contact of the entire strip to the acrylic substrate. After removing the release liner from the adhesive strip, the acrylic substrate with adhesive was gently applied adhesive side down to the Fineness of Grind Gauge. Application was done in a way that the strip spanned the 0.5-inch (1.3-cm) gap on the right side of the gauge and adhesive end edge was aligned with the shallow end of the gauge centering the long edge of adhesive along the length of the gauge (i.e., with 0.25-inch (0.64-cm) of adhesive on either side of the gap). The stack was inserted into a pneumatic driven hydraulic press (Fred S. Carver, Inc. Hydraulic Equipment. Menomonee Falls. WI) acrylic-side up sandwiched between two rubber gaskets. The shallow end of the gauge was aligned flush with the back of the press plate and the adhesive strip was centered in the center of the press plate. With sample in place, the press was set to 20 psi, activated, and held for five minutes. Ignoring bubbles less than 0.13-inch (0.32-cm) in diameter, the reported value was the point at which the adhesive transitions from contact to no contact as read on the side markings of the gauge in “mils” and estimated to the nearest half mil. Three test specimens were prepared, and the average was taken and reported.

### FTIR Migration Test

Fourier-transform infrared spectroscopy in attenuated total reflectance mode (ATR) was utilized to monitor the migration of curable component into the support layer at room temperature. The samples used in the test were prepared by first laminating Adhesive Film 1 onto one side of one of the curable foam support layers which have been discussed previously. For the measurements, a 0.5-inch (1.3 cm) wide strip of test sample laminates with the Adhesive Film 1 side directly applied and covering one fourth of the 2-inch length multi-bounce zinc selenide (ZnSe) ATR crystal with 45-degree angle of incidence. To ensure full contact, the films were gently hand-pressed to exclude air from the interface between the crystal and the adhesive. Every scan was captured with a new piece from the sample laminate, and the time interval between the scan and the time of lamination was recorded. The absorbance of the carbonyl group at 1726-cm⁻¹ was used as an indicator for normalization among samples measured at different time. The absorbance at 1380−cm⁻¹ (two-point baseline between 1355 and 1428-cm⁻¹ (was applied) was found unchanged for all the scans and independent of the migration which was used as the indicator for normalization. The change of the peak area associated with the reactive double bond absorbance of the acrylate group from the migrant component at 810-cm⁻¹ (two-point baseline between 795 and 826-cm⁻¹ was applied) was measured in every scan. The migration evidence was determined by the decrease of peak area at 810-cm⁻¹ under consecutive days of observation.

### EXAMPLES

Examples were prepared for dynamic shear adhesion using aluminum substrates 1-inch by 4-inch by 0.064-inch (2.5-cm by 10-cm by 1.6-mm) that were washed with MEK, then 50/50 water/IPA solution, and then three times with acetone, followed by air-drying for at least 2 minutes. The substrates were then activated with Activator. Activating was done by folding a small lab wipe three times to make about a one-inch strip which was dipped into the activator solution and wiped from the end of the substrate to the middle so that about two inches was coated. Activated substrates were allowed to air dry a minimum of two minutes before adhesive application. Specimens were made by cutting a 1-inch (2.5-cm) strip of double-sided tape described previously. One liner was removed, and double-sided tape laid across the activated portion of the substrate. A 2-inch (5.1-cm) firm rubber roller (MARSHALLTOWN, Marshalltown, IA) was used to insure full contact of the adhesive. Bonds were formed by removing the top release liner exposing the adhesive and introducing it to a second activated substrate. Closed bonds were then subjected to applied pressure of about 50-lbf (222-N) and the bonded test assembly was dwelled at room temperature (71° F. (22° C.)) for 7 days prior to testing. Using this format, Example 1 was made from the double-sided tape that was made from Curable Support Layer 1, Example 2 from Curable Support Layer 2, and Example 3 from Curable Support Layer 3. Comparative Example 1 was made in this fashion using double-sided tape made from PE. Example 4 was made by applying Example 1 to both sides of PET thereby generating the construction depicted in FIG. 5.

Examples for the Lang Test and FTIR Migration used the same nomenclature (e.g., Curable Foam Support Layer 1 corresponded with Example 1) except the sample preparation for each test is described in the corresponding Test Method descriptions for those tests and the testing was done without activator (i.e., on the uncured tapes).

### Example 5 Sample Preparation

Examples were prepared for dynamic shear adhesion using aluminum substrates 1-inch by 4-inch by 0.064-inch (2.5-cm by 10-cm by 1.6-mm) that were washed with MEK, then 50/50 water/IPA solution, and then three times with acetone, followed by air-drying for at least 2 minutes. Specimens were made by cutting a 1-inch (2.5-cm) strip of Example 5 Multilayer Tape described previously. The strip of tape was laid across the cleaned aluminum substrate and trimmed flush with the edges of the substrate forming a 1-inch by 1-inch bonding area. A 2-inch (5.1-cm) firm rubber roller (MARSHALLTOWN, Marshalltown, IA) was used to insure full contact of the adhesive. These specimens dwelled at room temperature (71° F. (22° C.)) for the lengths of time indicated in Table 4. After the dwelling period, a second set of substrates were cleaned as previously described and activated with Example 5 Activator. Activating was done by folding a small lab wipe three times to make about a one-inch strip which was dipped into the activator solution and wiped from the end of the substrate to the middle so that about two inches was coated. Activated substrates were allowed to air dry a minimum of two minutes before forming the bond. Bonds were then formed by removing the top release liner of the dwelled specimens exposing the adhesive and introducing it to the second activated substrate. Closed bonds were then subjected to applied pressure of about 50-lbf (222-N) and the bonded test assembly was dwelled at room temperature (71° F. (22° C.)) for 3 days prior to testing. The final construction is depicted in FIG. 7. Example 5 tape construction was made as described in the Preparation of Example 5 Multilayer Tape, and the dynamic shear adhesion bond was made by activating only one substrate thereby generating the construction depicted in FIG. 7.

TABLE 3

| | | Dynamic Shear | | |
|---|---|---|---|---|
| | | Adhesion | | Lang Test |
| | | Aluminum, 10″/min | Adhesion | 20 psi, |
| | | (25.4 cm/min), n = 6 | Failure | 5 min, n = 3 |
| | Tape Construction | psi (N/mm²) | Mode | mil (micron) |
| Example 1 | Adhesive Film 1 on Curable | 912.00 (6.29) | cohesive | 1.67 (42.4) |
| | Support Layer 1 | | | |
| Example 2 | Adhesive Film 1 on Curable | 777.20 (5.36) | cohesive | 1.83 (46.5) |
| | Support Layer 2 | | | |
| Example 3 | Adhesive Film 1 on Curable | 655.33 (4.52) | cohesive | 7 (177.8) |
| | Support Layer 3 | | | |
| Comparative | Adhesive Film 1 on PE | 48.70 (0.34) | 2-bond | 13 (330.2) |
| Example 1 | | | | |
| Example 4 | Example 1 applied to both | 298.03 (2.06) | cohesive | NT* |
| | sides of PET film | | | |
| Example 5 | Example 5 Multilayer Tape | 773.67 (5.32) | adhesive | NT |

*NT = not tested.

In Comparative Example 1, the failure mode indicates that migrating crosslinker did not move past the interface and become curable portion of the support layer. FIG. 6 shows that Examples 1, 2, and 4 have significant migration of crosslinker from the curable adhesive free-standing film into the curable foam support layer. Example 3 shows no migration because the curable foam support layer of that example is already full of crosslinker. Comparative Example 1 shows no substantial migration of crosslinker indicating the importance of migration to performance in some embodiments.

TABLE 4

| | Dynamic Shear | |
|---|---|---|
| | Adhesion | |
| | Aluminum, 10″/min | Percent (%) |
| Dwell Time on 1st | (25.4 cm/min), n = 6 | of Adhesion |
| Substrate (t) | psi (N/mm²) | at t = 0 |
| 0 | 773.67 (5.32) | 100% |
| 3 d | 879.33 (6.06) | 114% |
| 1 wk | 741.33 (5.11) | 96% |
| 2 wk | 798.33 (5.50) | 103% |
| 3 wk | 840.00 (5.79) | 109% |
| 4 wk | 776.00 (5.35) | 100% |
| 5 wk | 737.67 (5.09) | 95% |
| 6 wk | 863.33 (5.95) | 112% |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An adhesive system comprising:
a tape comprising:
a curable adhesive free-standing film adjacent to a curable foam support layer,
wherein the curable adhesive free-standing film comprises:
a) a film-forming polymer or oligomer;
b) a species comprising unsaturated free-radically polymerizable groups, which may be a) or a species other than a); and
c) a transition metal cation; and
an activator for adhesion of a curable adhesive free-standing film to a substrate, the activator comprising:
d) an oxidizing agent;
wherein the activator is a liquid at normal temperature and pressure.

2. The adhesive system of claim 1, wherein the foam is at least one of a closed cell foam or a syntactic foam.

3. The adhesive system of claim 1, wherein the curable foam support layer comprises a base polymer or oligomer which may be the same or different than the film-forming polymer or oligomer of the curable adhesive free-standing film.

4. The adhesive system of claim 3, wherein the base polymer or oligomer comprises a poly(meth)acrylate polymer or oligomer.

5. The adhesive system of claim 1, wherein the curable foam support layer comprises a crosslinker within the curable foam support layer.

6. The adhesive system of claim 5, wherein the crosslinker is different from the species comprising unsaturated free-radically polymerizable groups of the curable adhesive free-standing film.

7. The adhesive system of claim 5, wherein the crosslinker is the species comprising unsaturated free-radically polymerizable groups of the curable adhesive free-standing film that migrates into the curable support layer.

8. The adhesive system of claim 1, wherein the curable foam support layer further comprises a polymer modulus modifier comprising a polymer having a Tg of no greater than 100° C.

9. The adhesive system of claim 8, wherein the polymer modulus modifier comprises a polyvinyl acetal resin.

10. The adhesive system of claim 8, wherein the polymer modulus modifier comprises a high acid polymer.

11. The adhesive system of claim 1, wherein the curable foam support layer is hot melt processable.

12. The adhesive system of claim 1, wherein the curable adhesive free-standing film is a hot melt processable adhesive.

13. The adhesive system of claim 1, wherein the curable adhesive free-standing film is borne on a first major surface of the curable foam support layer.

14. The adhesive system of claim 1 further comprising a barrier film support layer adjacent to a surface of the curable foam support layer opposite the curable adhesive free-standing film.

15. The adhesive system of claim 1, wherein:
the curable adhesive free-standing film is a first curable adhesive free-standing film;
the tape additionally comprises a second curable adhesive free-standing film, wherein the second curable adhesive free-standing film comnprises components comprising:
a′) a film-forming polymer or oligomer;
b′) a species comprising unsaturated free-radically polymerizable groups, which may be a′) or a species other than a′); and
c′) a transition metal cation; and
the second curable adhesive free-standing film is adjacent to a surface of the curable foam support layer opposite the first curable adhesive free-standing film.

16. The adhesive system of claim 5, wherein the crosslinker is the same as the species comprising unsaturated free-radically polymerizable groups in the curable adhesive free-standing film.

17. The adhesive system of claim 1, wherein the curable adhesive free-standing film is directly bound to a first major surface of the curable foam support layer.

18. The adhesive system of claim 1 further comprising a secondary adhesive layer adjacent to a surface of the curable foam support layer opposite the curable adhesive free-standing film.

19. The adhesive system of claim 1, wherein the activator comprises a film-forming polymer or oligomer.

20. The adhesive system of claim 1, wherein the activator comprises no tackifier, wherein the activator comprises no species comprising unsaturated free-radically polymerizable groups, or wherein the activator comprises no tackifier and no species comprising unsaturated free-radically polymerizable groups.
